(19) United States
(12) Patent Application Publication
(10) Pub. No.: US 2025/0056516 A1
(43) Pub. Date: Feb. 13, 2025

(54) COMMUNICATION METHOD, COMMUNICATION DEVICE, AND COMMUNICATION SYSTEM

(71) Applicant: Sony Group Corporation, Tokyo (JP)

(72) Inventor: Hiroaki TAKANO, Tokyo (JP)

(73) Assignee: Sony Group Corporation, Tokyo (JP)

(21) Appl. No.: 18/718,809

(22) PCT Filed: Mar. 28, 2022
(86) PCT No.: PCT/JP2022/015094

§ 371 Date: Jun. 12, 2024

(30) Foreign Application Priority Data
Dec. 27, 2021 (JP) 2021-213200

(51) Int. Cl. H04W 72/0457; H04W 48/18; H04W 72/231

(52) U.S. Cl. CPC H04W 72/0457; H04W 48/18; H04W 72/231

(57) ABSTRACT

In a communication method, a plurality of BWPs is set as one BWP group for a predetermined operation, and communication related to the predetermined operation is performed using the plurality of BWPs included in the BWP group.

### FIELD

The present disclosure relates to a communication method, a communication device, and a communication system.

### BACKGROUND

In recent years, in cellular wireless communication, a new technology has been introduced in order to cope with diversification of communication services. For example, in 5G, a component carrier can be divided into a plurality of band width parts (BWP) and used. Further, in 5G, a single network infrastructure can be divided into a plurality of network slices and used. In many cases, one network slice is used in one use case. A BWP is considered as a means for implementing network slicing, and generally, the BWP and the network slicing are mapped one-to-one.

### CITATION LIST

### Patent Literature

Patent Literature 1: Japanese Translation of PCT International Application Publication No. 2019-530357

### SUMMARY

### Technical Problem

With diversification of communication services, it is assumed that many network slices are used in one use case. However, the conventional BWP is not a technology assuming that many network slices are used in one use case. Thus, the conventional technology cannot cope with diversification of communication services.

Therefore, the present disclosure proposes a communication method, a communication device, and a communication system capable of coping with diversification of communication services.

Note that the above problem or object is merely one of a plurality of problems or objects that can be solved or achieved by the plurality of embodiments disclosed in the present description.

### Solution to Problem

In order to solve the above problem, a communication method according to one embodiment of the present disclosure, includes: setting a plurality of BWPs as one BWP group for a predetermined operation; and performing communication related to the predetermined operation using the plurality of BWPs included in the BWP group.

### BRIEF DESCRIPTION OF DRAWINGS

FIG. 1 is an example in which different BWPs are arranged in one CC in a frequency direction.

FIG. 2 is an example in which different BWPs are arranged in one CC in a time direction.

FIG. 3 is a diagram illustrating an example of use of a BWP in a case of FDD.

FIG. 4 is a diagram illustrating an example of use of a BWP in a case of TDD.

FIG. 5 is a diagram for describing network slicing.

FIG. 6 is a diagram illustrating an example of a use case of network slicing.

FIG. 7 is a diagram illustrating another example of a use case of the network slicing.

FIG. 8 is a diagram illustrating a configuration example of a communication system according to an embodiment of the present disclosure.

FIG. 9 is a diagram illustrating a configuration example of a management device according to the embodiment of the present disclosure.

FIG. 10 is a diagram illustrating a configuration example of a base station according to the embodiment of the present disclosure.

FIG. 11 is a diagram illustrating a configuration example of a terminal device according to the embodiment of the present disclosure.

FIG. 12 is a diagram illustrating an example of 5G architecture.

FIG. 13 is a diagram illustrating a configuration of conventional S-NSSAI.

FIG. 14 is a diagram illustrating a configuration example of S-NSSAI of the present embodiment.

FIG. 15 is a diagram illustrating another configuration example of the S-NSSAI of the present embodiment.

FIG. 16 is a sequence diagram illustrating an operation of grouping and setting a plurality of network slices.

FIG. 17 is a diagram illustrating an example of setting information indicating that a plurality of BWPs is grouped.

FIG. 18 is a diagram for describing a method of switching a BWP using DCI.

FIG. 19 is a diagram for describing a method of switching a BWP using an inactive timer.

FIG. 20 is a diagram illustrating a definition example of pattern information.

FIG. 21 is a diagram illustrating a setting example of pattern information.

FIG. 22 is a diagram illustrating an operation example in the setting example illustrated in FIG. 21.

FIG. 23 is a diagram illustrating a setting example of a method of switching a BWP switching pattern.

FIG. 24 is a diagram illustrating an example of a method of switching of a BWP group.

FIG. 25 is a diagram illustrating a method of switching a BWP group using a group ID.

FIG. 26 is a diagram for describing a method of measuring switch completion timing of a BWP group.

FIG. 27 is a sequence diagram illustrating a switch operation using an inactive timer.

### DESCRIPTION OF EMBODIMENTS

Hereinafter, embodiments of the present disclosure will be described in detail with reference to the drawings. Note that in each of the following embodiments, the same parts are denoted by the same reference numerals, and redundant description will be omitted.

In addition, in the present description and the drawings, a plurality of components having substantially the same functional configuration may be distinguished by attaching different numerals after the same reference numerals. For example, a plurality of configurations having substantially the same functional configuration is distinguished as terminal devices 30₁, 30₂, and 30₃ as necessary. However, in a case where it is not particularly necessary to distinguish each of a plurality of components having substantially the same functional configuration, only the same reference numeral is attached. For example, in a case where it is not necessary to particularly distinguish the terminal devices 30₁, 30₂, and 30₃, they are simply referred to as terminal devices 30.

One or more embodiments (examples and modifications) described below can each be implemented independently. On the other hand, at least some of the plurality of embodiments described below may be appropriately combined with at least some of other embodiments. The plurality of embodiments may include novel features different from each other. Therefore, the plurality of embodiments can contribute to solving different objects or problems, and can exhibit different effects.

Note that the description will be given in the following order.
1. Outline
1-1. BWP and network slicing
1-2. Summary of problems and solutions of present embodiment
2. Configuration of communication system
2-1. Configuration example of communication system
2-2. Configuration example of management device
2-3. Configuration example of base station
2-4. Configuration example of terminal device
3. Network architecture
4. First Embodiment
4-1. Problem
4-2. Solution
5. Second Embodiment
5-1. Problem
5-2. Solution
6. Third Embodiment
6-1. Problem
6-2. Solution 1
6-3. Solution 2
7. Fourth Embodiment
7-1. Problem
7-2. Solution
8. Modification
9. Conclusion

### 1. OUTLINE

Radio access technology (RAT) such as long term evolution (LTE) and new radio (NR) has been studied in the 3rd generation partnership project (3GPP). LTE and NR are a type of cellular communication technology, and enable mobile communication of a terminal device by arranging a plurality of areas covered by a base station in a cell shape. At this time, a single base station may manage a plurality of cells.

Note that, in the following description, “LTE” includes LTE-A (LTE-Advanced), LTE-A Pro (LTE-Advanced Pro), and E-UTRA (Evolved Universal Terrestrial Radio Access). Further, the NR includes NRAT (New Radio Access Technology) and FE-UTRA (Further E-UTRA). In the following description, a cell corresponding to LTE is referred to as an LTE cell, and a cell corresponding to NR is referred to as an NR cell.

NR is a next generation (fifth generation) radio access technology (RAT) of LTE. The NR is a radio access technology that can support various use cases including enhanced mobile broadband (eMBB), massive machine type communications (mMTC), and ultra-reliable and low latency communications (URLLC). In NR, various technologies have been introduced aiming at a technical framework corresponding to usage scenarios, requirement conditions, arrangement scenarios, and the like in these use cases. For example, in the NR, in order to cope with diversification of communication services, new technologies such as a band width part (BWP) and network slicing are introduced.

### 1-1. BWP and Network Slicing

Before describing an outline of the problems and solutions of the present embodiment, a BWP (Band Width Part) and network slicing will be described below.

### 1-1-1. BWP

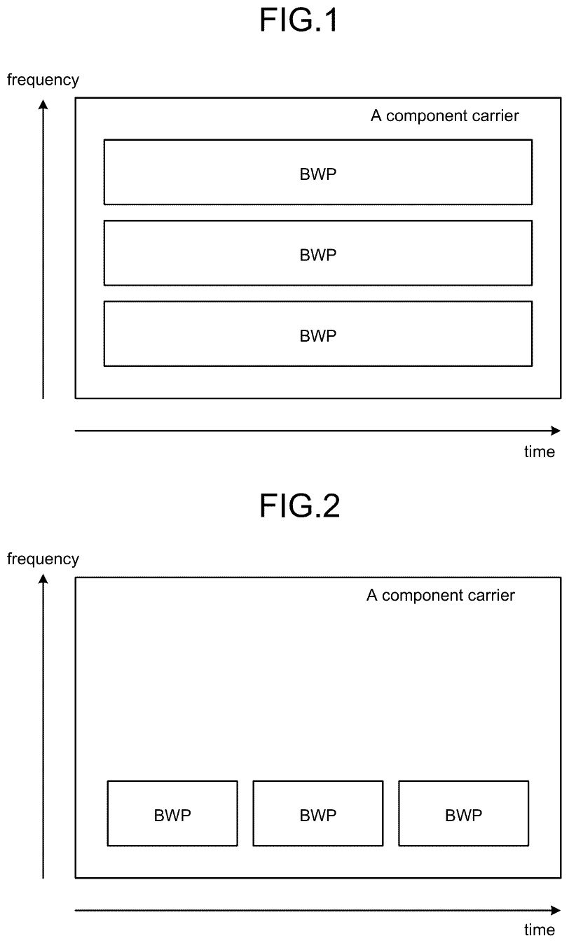

FIGS. 1 and 2 are diagrams for describing BWP. In new radio (NR), a component carrier having one operation bandwidth can be divided into a plurality of regions and used. The divided regions are band width parts (BWP). The BWP has been standardized as a basic frame format of New Radio (NR) of 3GPP Release 15.

In the LTE, subcarrier spacing is fixed at 15 kHz, but in NR, different subcarrier spacings can be used. Specifically, in the NR, the subcarrier spacings can be set to 60 kHz, 120 kHz, and 240 kHz. Increasing the subcarrier spacing needs less time for OFDM symbols. For example, in the LTE, one slot (=14 OFDM symbols) can be transmitted in 1 ms, but in NR, two slots can be transmitted at a subcarrier spacing of 60 kHz, four slots can be transmitted at a subcarrier spacing of 120 kHz, and eight slots can be transmitted at a subcarrier spacing of 240 kHz. That is, when the subcarrier spacing is increased, the required time per OFDM symbol is reduced, and a frame configuration suitable for transmission and reception of low-delay communication can be obtained.

In the NR, by using the BWP, even one component carrier can simultaneously provide a plurality of regions having different subcarrier spacings.

### 1-1-2. Number of Active BWPs

A base station can simultaneously transmit and receive a plurality of BWPs. However, a terminal device can simultaneously transmit and receive only one BWP. However, in the future, it is assumed that there will be a terminal device capable of simultaneously transmitting and receiving a plurality of BWPs according to the improvement of the capability of the terminal device. In the present embodiment, both a case where the terminal device can handle only one active BWP (Active BWP) and a case where the terminal device can handle a plurality of active BWPs at the same time are considered.

### 1-1-3. Relationship Between CC and BWP

Although the present embodiment has been described focusing on multiple BWPs (Multiple BWPs), the technology described in the present embodiment is also applicable to a case where there is a plurality of component carriers (CCs). The CC is an operating frequency band. There is a case where a plurality of BWPs exists in one CC. BWPs for different CCs can also be used simultaneously in the 3GPP Release 15 standard. That is, the BWP for CC1 and the BWP for CC2 can be used simultaneously.

FIG. 1 illustrates an example in which different BWPs are arranged in one CC in a frequency direction. Further, FIG. 2 illustrates an example in which different BWPs are arranged in one CC in a time direction. In a case where the BWP is provided in the time direction, a gap of about 1 ms is provided when the BWP is switched. Thus, it takes time for the switching to be stable. Even in a case where the BWP is provided in the frequency direction, the terminal device can handle one BWP at the same time in many cases. In this case, it takes about 1 ms for the terminal device to switch the frequency and stabilize the operation. A terminal device that can handle two or more BWPs at the same time is assumed to come out in the future although the cost increases.

### 1-1-4. BWP and FDD/TDD

NR includes two methods of frequency division duplex (FDD) and time division duplex (TDD). FDD is a method of using different frequency bands on a downlink and an uplink. Therefore, it is possible to use the downlink and the uplink at the same time. TDD is a method of using a downlink time and an uplink time alternately in one frequency band. At present, FDD and TDD are selectively used depending on a frequency environment that can be prepared.

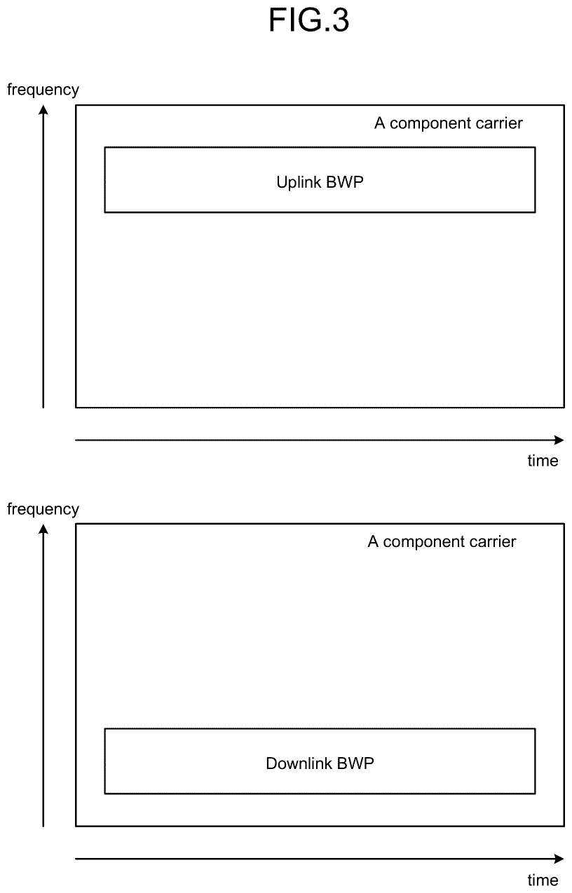

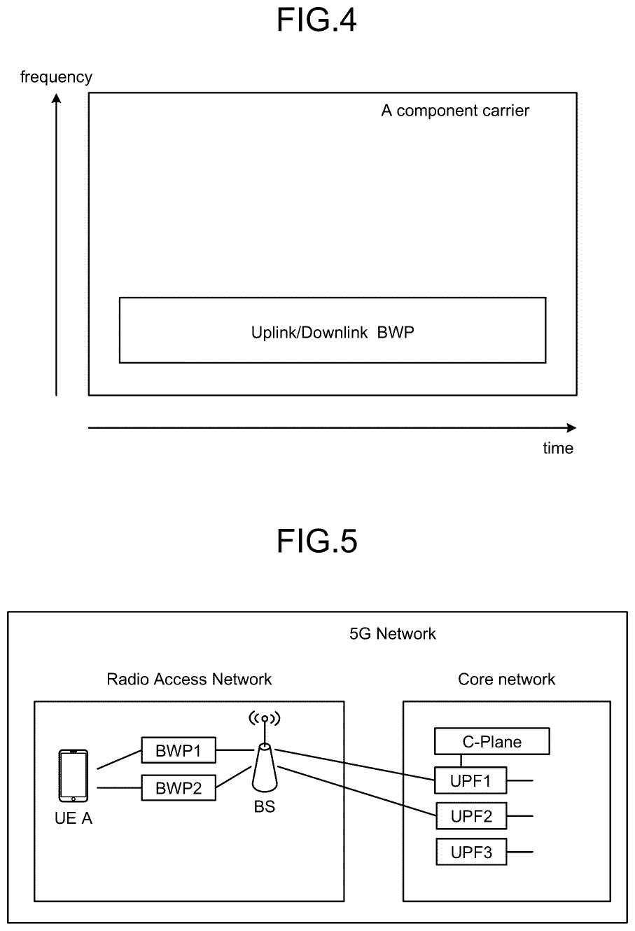

FIG. 3 is a diagram illustrating a usage example of a BWP in the case of FDD. Further, FIG. 4 is a diagram illustrating a usage example of the BWP in the case of TDD. In the case of TDD, both the downlink and the uplink belong to the same BWP, as illustrated in FIG. 4. On the other hand, in the case of FDD, as illustrated in FIG. 3, the BWP is divided into a downlink BWP and an uplink BWP. In the case of FDD, it can be clearly understood that BWP IDs are the same and belong to one network slice. In the case of FDD, it is possible to set different subcarrier spacings in the downlink and the uplink. When using only one BWP in TDD, the downlink and uplink will have the same subcarrier spacing.

### 1-1-5. BWP and Network Slicing

In 5G, a concept of network slicing is introduced. Network slicing is a technique for dividing a single network infrastructure into multiple networks. Using the network slicing allows for simultaneous use of networks of different nature. It is desirable that each network slice is independent. In addition, it is desirable that the radiation state of a specific network slice hardly affects other network slices.

Different BWPs may provide different subcarrier spacings. That is, the BWP is a means for implementing the network slicing. Further, the different BWPs are orthogonal in frequency or time. Thus, the different BWPs are independent time-frequency resources. Therefore, it can be said that the BWPs have a small degree of influence on each other like the network slice.

In this manner, the BWP is used as a means for implementing the network slicing on a radio access network (RAN) side. FIG. 5 is a diagram for describing the network slicing. In the example of FIG. 5, the network slicing on a core network side is implemented by preparing independent computer resources (UPF). Note that a component carrier (CC) can also be said to be one of means for implementing network slicing. The network slicing on the RAN side is implemented by CC and BWP, and the network slicing on the core network side is implemented by preparing a plurality of independent computer resources, that is, user plane functions (UPF).

### 1-2. Outline of Problems and Solutions of Present Embodiment

Based on the above, an outline of problems and solutions of the present embodiment will be described.

Typically, one network slice is used in one use case. With diversification of communication services, it is assumed that many network slices are used in one use case.

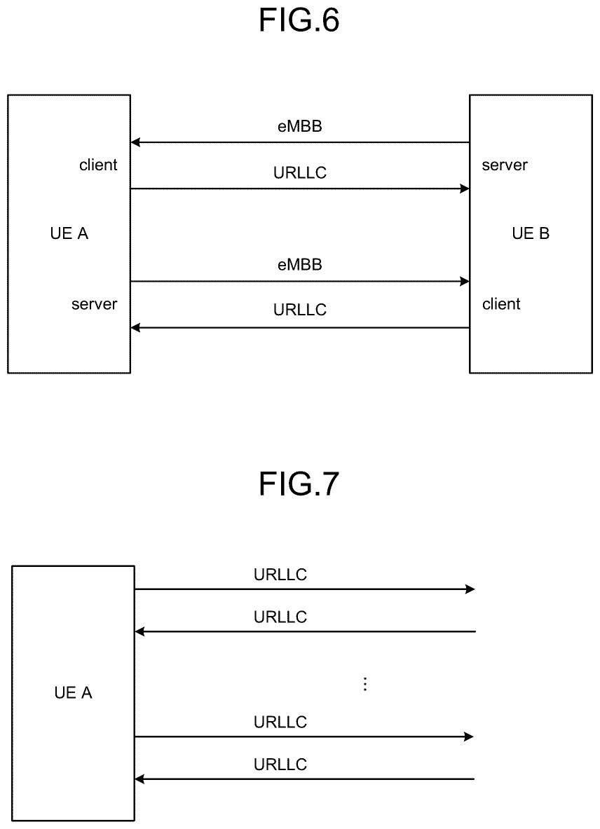

For example, use cases of extended reality (XR) such as virtual reality (VR), augmented reality (AR), and mixed reality (MR) will be considered. In the case of XR, a small amount of data for a head mounted display of a user is transmitted on the uplink, and based on the data, a large amount of video data is transmitted from the network on the downlink. In the future, it is assumed that users may directly communicate with each other through XR. FIG. 6 is a diagram illustrating an example of a use case of network slicing. For example, there is a case where UE of a user A and UE of a user B are on the server side and the client side, respectively, and perform XR.

Further, in a case where control is performed from one UE to sensors in a large number of regions, it is assumed that a large number of URLLC network slices are included. FIG. 7 is a diagram illustrating another example of the use case of the network slicing. In any case, it is assumed that the number of network slices increases in future use cases.

However, the conventional BWP is not a technology assuming that many network slices are used in one use case. Thus, the conventional technology cannot cope with diversification of communication services. For example, a case where a certain BWP is switched to another BWP is considered. The BWP and the network slice are mapped on a one-to-one basis, and thus, in a case where a plurality of network slices is dependent on one service, a plurality of BWPs is also dependent on the service. In this case, in the conventional technology, even if it is known that a plurality of BWPs depends on one service, the plurality of BWPs needs to be individually controlled by downlink control information (DCI) or the like. This is extremely inefficient.

Accordingly, in the present embodiment, a communication device such as a terminal device sets a plurality of BWPs as one BWP group for a predetermined operation (for example, XR service or sensor communication) on the basis of a notification from a base station or the like. Then, the communication device performs communication related to a predetermined operation using a plurality of BWPs included in the BWP group. At this time, the communication device may receive pattern information describing a switching pattern of BWPs in the BWP group from the base station, and switch the BWP among a plurality of BWPs in the BWP group according to the pattern information.

Thus, it is possible to efficiently handle a plurality of BWPs dependent on one service, and thus, it is possible to cope with diversification of communication services.

### 2. CONFIGURATION OF COMMUNICATION SYSTEM

While the outline of the present embodiment has been described above, before the present embodiment is described in detail, a configuration of a communication system 1 including an information processing device of the present embodiment will be described. Note that the communication system can be rephrased as an information processing system.

### 2-1. Configuration Example of Communication System

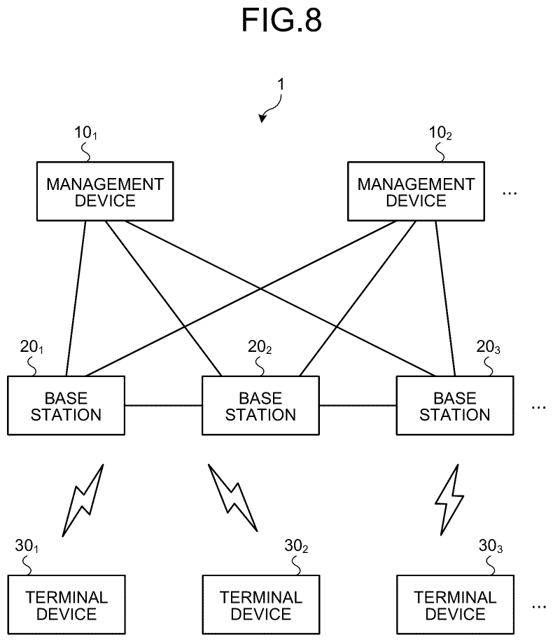

FIG. 8 is a diagram illustrating a configuration example of the communication system 1 according to the embodiment of the present disclosure. The communication system 1 includes a management device 10, a base station 20, and a terminal device 30. The communication system 1 provides the user with a wireless network capable of mobile communication by wireless communication devices constituting the communication system 1 operating in cooperation. The wireless network of the present embodiment includes, for example, a radio access network and a core network. Note that, in the present embodiment, the wireless communication device is a device having a wireless communication function, and corresponds to the base station 20 and the terminal device 30 in the example of FIG. 8.

The communication system 1 may include a plurality of the management devices 10, a plurality of the base stations 20, and a plurality of the terminal devices 30. In the example of FIG. 8, the communication system 1 includes management devices 10₁ and 10₂ and the like as the management device 10, base stations 20₁, 20₂, 20₃, and the like as the base station 20, and terminal devices 30₁, 30₂, 30₃, and the like as the terminal device 30.

Note that the devices in the drawings may be considered as devices in the logical sense. That is, a part of the device in the drawing may be implemented by a virtual machine (VM), Container, Docker, or the like, and these may be implemented on physically the same hardware.

Note that the communication system 1 may support a radio access technology (RAT) such as long term evolution (LTE) or new radio (NR). LTE and NR are a type of cellular communication technology, and enable mobile communication of a terminal device by arranging a plurality of areas covered by a base station in a cell shape. Note that the radio access method used by the communication system 1 is not limited to LTE and NR, and may be another radio access method such as Wideband Code Division Multiple Access (W-CDMA) or Code Division Multiple Access 2000 (cdma 2000).

In addition, the base station or the relay station constituting the communication system 1 may be a ground station or a non-ground station. The non-ground station may be a satellite station or an aircraft station. If the non-ground station is a satellite station, the communication system 1 may be a Bent-pipe (Transparent) type mobile satellite communication system.

Note that, in the present embodiment, the ground station (it is also referred to as a ground base station) refers to a base station (a relay station) installed on the ground. Here, the “ground” is a ground in a broad sense including not only land but also underground, on water, and under water. Note that, in the following description, the description of “ground station” may be replaced with “gateway”.

Note that an LTE base station may be referred to as an evolved node B (eNodeB) or an eNB. In addition, an NR base station may be referred to as a gNodeB or a gNB. In addition, in the LTE and the NR, a terminal device (also referred to as a mobile station or a terminal) may be referred to as user equipment (UE). Note that the terminal device is a type of communication device, and is also referred to as a mobile station or a terminal.

In the present embodiment, the concept of the communication device includes not only a portable mobile device (terminal device) such as a mobile terminal but also a device installed in a structure or a mobile object. The structure or the mobile object itself may be regarded as the communication device. In addition, the concept of the communication device includes not only a terminal device but also a base station and a relay station. The communication device is a type of a processing device and an information processing device. Further, the communication device can be rephrased as a transmission device or a reception device.

Hereinafter, a configuration of each device constituting the communication system 1 will be specifically described. Note that the configuration of each device described below is merely an example. The configuration of each device may be different from the configuration described below.

### 2-2. Configuration Example of Management Device

Next, a configuration of the management device 10 will be described.

The management device 10 is an information processing device (computer) that manages a wireless network. For example, the management device 10 is an information processing device that manages communication of the base station 20. The management device 10 may be, for example, a device having a function as a mobility management entity (MME). The management device 10 may be a device having a function as an access and mobility management function (AMF) and/or a session management function (SMF). Of course, the functions of the management device 10 are not limited to the MME, the AMF, and the SMF. The management device 10 may be a device having a function as a network slice selection function (NSSF), an authentication server function (AUSF), a policy control function (PCF), or a unified data management (UDM). In addition, the management device 10 may be a device having a function as a home subscriber server (HSS).

Note that the management device 10 may have a function of a gateway. For example, the management device 10 may have a function as a serving gateway (S-GW) or a packet data network gateway (P-GW). In addition, the management device 10 may have a function of a user plane function (UPF). At this time, the management device 10 may have a plurality of UPFs. Each of the plurality of UPFs may function as a UPF resource of a different network slice.

The core network includes a plurality of network functions, and each network function may be aggregated into one physical device or distributed to a plurality of physical devices. That is, the management device 10 can be arranged in a distributed manner in a plurality of devices. Furthermore, this distributed arrangement may be controlled to be performed dynamically. The base station 20 and the management device 10 constitute one network, and provide a wireless communication service to the terminal device 30. The management device 10 is connected to the Internet, and the terminal device 30 can use various services provided via the Internet via the base station 20.

Note that the management device 10 is not necessarily a device constituting the core network. For example, it is assumed that the core network is a core network of Wideband Code Division Multiple Access (W-CDMA) or Code Division Multiple Access 2000 (cdma 2000). At this time, the management device 10 may be a device that functions as a radio network controller (RNC).

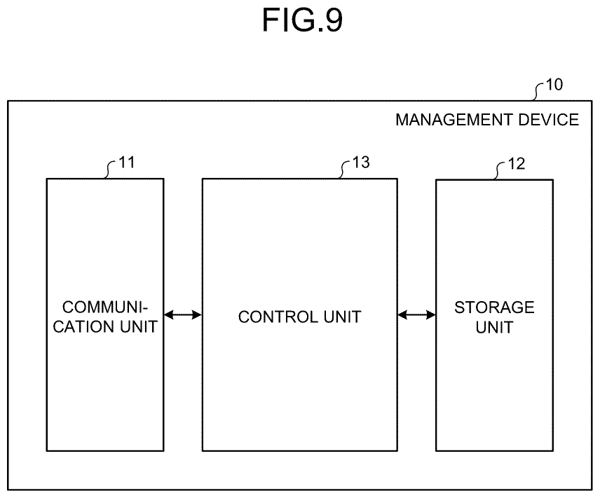

FIG. 9 is a diagram illustrating a configuration example of the management device 10 according to the embodiment of the present disclosure. The management device 10 includes a communication unit 11, a storage unit 12, and a control unit 13. Note that the configuration illustrated in FIG. 9 is a functional configuration, and the hardware configuration may be different from the functional configuration. In addition, the functions of the management device 10 may be statically or dynamically distributed and implemented in a plurality of physically separated configurations. For example, the management device 10 may include a plurality of server devices.

The communication unit 11 is a communication interface for communicating with other devices. The communication unit 11 may be a network interface or a device connection interface. For example, the communication unit 11 may be a local area network (LAN) interface such as a network interface card (NIC), or may be a USB interface including a universal serial bus (USB) host controller, a USB port, and the like. In addition, the communication unit 11 may be a wired interface or a wireless interface. The communication unit 11 functions as a communication means of the management device 10. The communication unit 11 communicates with the base station 20 and the like under the control of the control unit 13.

The storage unit 12 is a data readable/writable storage device such as a dynamic random access memory (DRAM), a static random access memory (SRAM), a flash memory, or a hard disk. The storage unit 12 functions as a storage means of the management device 10. The storage unit 12 stores, for example, a connection state of the terminal device 30. For example, the storage unit 12 stores a radio resource control (RRC) state and an EPS connection management (ECM) state, or a 5G system connection management (CM) state of the terminal device 30. The storage unit 12 may function as a home memory that stores position information of the terminal device 30.

The control unit 13 is a controller that controls each unit of the management device 10. The control unit 13 is implemented by, for example, a processor such as a central processing unit (CPU), a micro processing unit (MPU), or a graphics processing unit (GPU). For example, the control unit 13 is implemented by the processor executing various programs stored in the storage device inside the management device 10 using a random access memory (RAM) or the like as a work area. Note that the control unit 13 may be implemented by an integrated circuit such as an application specific integrated circuit (ASIC) or a field programmable gate array (FPGA). Any of the CPU, the MPU, the GPU, the ASIC, and the FPGA can be regarded as a controller.

### 2-3. Configuration Example of Base Station

Next, a configuration of the base station 20 will be described.

The base station 20 is a wireless communication device that performs wireless communication with the terminal device 30. The base station 20 may be configured to wirelessly communicate with the terminal device 30 via a relay station, or may be configured to directly wirelessly communicate with the terminal device 30.

The base station 20 is a type of a communication device. More specifically, the base station 20 is a device corresponding to a radio base station (Base Station, Node B, eNB, gNB, or the like) or a wireless access point. The base station 20 may be a wireless relay station. In addition, the base station 20 may be an optical extension device called a remote radio head (RRH) or a radio unit (RU). Furthermore, the base station 20 may be a receiving station such as a field pickup unit (FPU). In addition, the base station 20 may be an integrated access and backhaul (IAB) donor node or an IAB relay node that provides a wireless access line and a radio backhaul line by time division multiplexing, frequency division multiplexing, or space division multiplexing.

Note that the radio access technology used by the base station 20 may be a cellular communication technology or a wireless LAN technology. Of course, the radio access technology used by the base station 20 is not limited thereto, and may be another wireless access technology. For example, the radio access technology used by the base station 20 may be a low power wide area (LPWA) communication technology. Of course, the wireless communication used by the base station 20 may be radio communication using millimeter waves. In addition, the wireless communication used by the base station 20 may be wireless communication using radio waves or wireless communication (optical radio) using infrared rays or visible light. Further, the base station 20 may be capable of non-orthogonal multiple access (NOMA) communication with the terminal device 30. Here, the NOMA communication is communication using a non-orthogonal resource (transmission, reception, or both). Note that the base station 20 may be able to perform the NOMA communication with another base station 20.

Note that the base stations 20 may be capable of communicating with each other via an interface between a base station and a core network (for example, NG Interface, S1 Interface, or the like). This interface may be either wired or wireless. Furthermore, the base stations may be capable of communicating with each other via an inter-base station interface (for example, Xn Interface, X2 Interface, S1 Interface, F1 Interface, and the like). This interface may be either wired or wireless.

Note that the concept of the base station includes not only a donor base station but also a relay base station (also referred to as a relay station). For example, the relay base station may be any one of RF Repeater, Smart Repeater, and Intelligent Surface. Further, the concept of the base station includes not only a structure having a function of the base station but also a device installed in the structure.

The structure is, for example, a building such as a high-rise building, a house, a steel tower, a station facility, an airport facility, a harbor facility, an office building, a school building, a hospital, a factory, a commercial facility, or a stadium. Note that the concept of a structure includes not only a building but also a construction (non-building structure) such as a tunnel, a bridge, a dam, a wall, or an iron pillar, and equipment such as a crane, a gate, or a windmill. Further, the concept of the structure includes not only a structure on land (on the ground in a narrow sense) or underground, but also a structure on water such as a platform or a megafloat, and a structure under water such as a marine observation facility. The base station may be referred to as an information processing device.

The base station 20 may be a donor station or a relay station (relay station). In addition, the base station 20 may be a fixed station or a mobile station. The mobile station is a wireless communication device (for example, the base station) configured to be movable. At this time, the base station 20 may be a device installed in a mobile object or may be a mobile object itself. For example, a relay station having mobility can be regarded as the base station 20 as a mobile station. Further, an apparatus that is originally capable of moving, such as a vehicle, an unmanned aerial vehicle (UAV) typified by a drone, or a smartphone, and has a function of a base station (at least a part of the function of the base station) also corresponds to the base station 20 as a mobile station.

Here, the mobile object may be a mobile terminal such as a smartphone or a mobile phone. In addition, the mobile object may be a mobile object (for example, a vehicle such as an automobile, a bicycle, a bus, a truck, a motorcycle, a train, or a linear motor car) that moves on land (on the ground in a narrow sense) or a mobile object (for example, the subway) that moves underground (for example, in the tunnel). In addition, the mobile object may be a mobile object (for example, a ship such as a passenger ship, a cargo ship, or a hovercraft) that moves over water or a mobile object (for example, a submersible vessel such as a submersible, a submarine, and an unmanned submersible) that moves under water. Note that the mobile object may be a mobile object (for example, an aircraft such as an airplane, an airship, or a drone) that moves in the atmosphere.

In addition, the base station 20 may be a ground base station (ground station) installed on the ground. For example, the base station 20 may be a base station arranged in a structure on the ground, or may be a base station installed in a mobile object moving on the ground. More specifically, the base station 20 may be an antenna installed in a structure such as a building and a signal processing device connected to the antenna. Of course, the base station 20 may be a structure or a mobile object itself. The “ground” is a ground in a broad sense including not only land (ground in a narrow sense) but also underground, on water, and under water. Note that the base station 20 is not limited to a ground base station. For example, in a case where the communication system 1 is a satellite communication system, the base station 20 may be an aircraft station. From the perspective of a satellite station, an aircraft station located on the earth is a ground station.

Note that the base station 20 is not limited to a ground station. The base station 20 may be a non-ground base station (non-ground station) capable of floating in the air or space. For example, the base station 20 may be an aircraft station or a satellite station.

The satellite station is a satellite station capable of floating outside the atmosphere. The satellite station may be a device mounted on a space mobile object such as an artificial satellite, or may be a space mobile object itself. The space mobile object is a mobile object that moves outside the atmosphere. Examples of the space mobile object include artificial celestial bodies such as artificial satellites, spacecrafts, space stations, and probes. Note that the satellite to be the satellite station may be any of a low earth orbiting (LEO) satellite, a medium earth orbiting (MEO) satellite, a geostationary earth orbiting (GEO) satellite, and a highly elliptical orbiting (HEO) satellite. Of course, the satellite station may be a device mounted on the low earth orbiting satellite, the medium earth orbiting satellite, the geostationary earth orbiting satellite, or the highly elliptical orbiting satellite.

The aircraft station is a wireless communication device capable of floating in the atmosphere, such as an aircraft. The aircraft station may be a device mounted on an aircraft or the like, or may be an aircraft itself. Note that the concept of an aircraft includes not only heavy aircraft such as an airplane and a glider but also light aircraft such as a balloon and an airship. Further, the concept of an aircraft includes not only a heavy aircraft and a light aircraft but also a rotorcraft such as a helicopter and an autogyro. Note that the aircraft station (alternatively, an aircraft on which an aircraft station is mounted) may be an unmanned aerial vehicle such as a drone.

Note that the concept of the unmanned aerial vehicle also includes unmanned aircraft systems (UAS) and tethered UAS. Further, the concept of unmanned aerial vehicles also includes Lighter than Air UAS (LTA) and Heavier than Air UAS (HTA). Other concepts of unmanned aerial vehicles also include High Altitude UAS Platforms (HAPs).

The size of coverage of the base station 20 may be large like a macro cell or small like a pico cell. Of course, the size of the coverage of the base station 20 may be extremely small like a femto cell. In addition, the base station 20 may have a beamforming capability. In this case, in the base station 20, a cell or a service area may be formed for each beam.

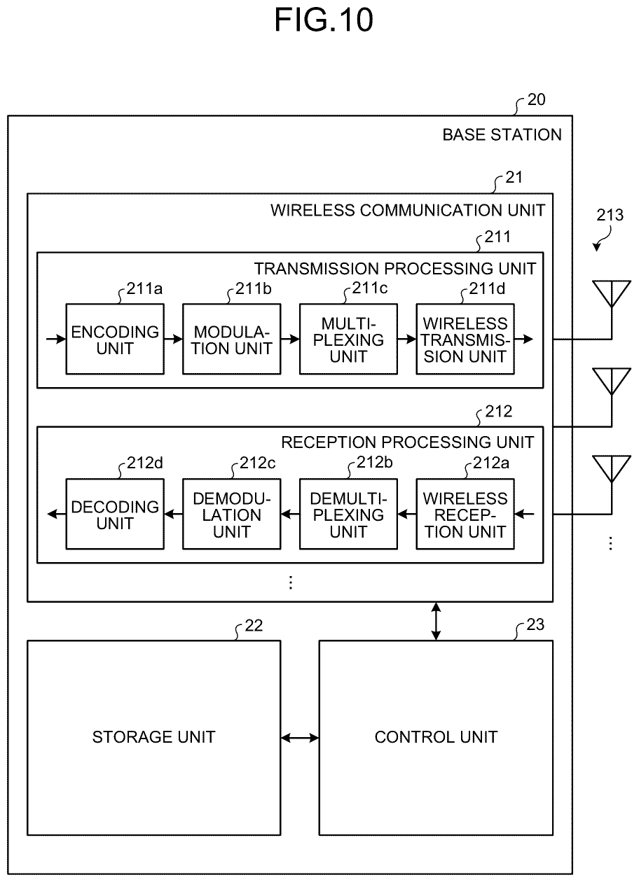

FIG. 10 is a diagram illustrating a configuration example of the base station 20 according to the embodiment of the present disclosure. The base station 20 includes a wireless communication unit 21, a storage unit 22, and a control unit 23. Note that the configuration illustrated in FIG. 10 is a functional configuration, and the hardware configuration may be different from the functional configuration. In addition, the functions of the base station 20 may be implemented in a distributed manner in a plurality of physically separated configurations.

The wireless communication unit 21 is a signal processing unit for wirelessly communicating with other wireless communication devices (for example, the terminal device 30). The wireless communication unit 21 operates under the control of the control unit 23. The wireless communication unit 21 corresponds to one or a plurality of wireless access methods. For example, the wireless communication unit 21 supports both the NR and the LTE. The wireless communication unit 21 may be compatible with W-CDMA or cdma 2000 in addition to the NR or the LTE. In addition, the wireless communication unit 21 may support an automatic retransmission technology such as hybrid automatic repeat request (HARQ).

The wireless communication unit 21 includes a transmission processing unit 211, a reception processing unit 212, and an antenna 213. The wireless communication unit 21 may include a plurality of the transmission processing units 211, a plurality of the reception processing units 212, and a plurality of the antennas 213. Note that, in a case where the wireless communication unit 21 supports a plurality of wireless access methods, each unit of the wireless communication unit 21 can be configured individually for each wireless access method. For example, the transmission processing unit 211 and the reception processing unit 212 may be individually configured by the LTE and the NR. In addition, the antenna 213 may include a plurality of antenna elements (for example, a plurality of patch antennas). In this case, the wireless communication unit 21 may be configured to be beamformable. The wireless communication unit 21 may be configured to be able to perform polarization beamforming using vertically polarized waves (V-polarized waves) and horizontally polarized waves (H-polarized waves).

The transmission processing unit 211 performs a process of transmitting downlink control information and downlink data. For example, the transmission processing unit 211 encodes the downlink control information and the downlink data input from the control unit 23 using an encoding method such as block encoding, convolutional encoding, turbo encoding, or the like. Here, the encoding may be performed by polar code encoding or low density parity check code (LDPC code) encoding. Then, the transmission processing unit 211 modulates the coded bits by a predetermined modulation method such as BPSK, QPSK, 16 QAM, 64 QAM, or 256 QAM. In this case, signal points on a constellation do not necessarily have to be equidistant. The constellation may be a non uniform constellation (NUC). Then, the transmission processing unit 211 multiplexes the modulation symbol of each channel and a downlink reference signal and arranges the multiplexed symbols in a predetermined resource element. Then, the transmission processing unit 211 performs various types of signal processing on the multiplexed signal. For example, the transmission processing unit 211 performs processing such as conversion to a frequency domain by fast Fourier transform, addition of a guard interval (cyclic prefix), generation of a baseband digital signal, conversion to an analog signal, quadrature modulation, up-conversion, removal of an extra frequency component, and amplification of power. The signal generated by the transmission processing unit 211 is transmitted from the antenna 213.

The reception processing unit 212 processes the uplink signal received via the antenna 213. For example, the reception processing unit 212 performs, on the uplink signal, down-conversion, removal of an unnecessary frequency component, control of an amplification level, quadrature demodulation, conversion to a digital signal, removal of a guard interval (cyclic prefix), extraction of a frequency domain signal by fast Fourier transform, and the like. Then, the reception processing unit 212 demultiplexes an uplink channel such as a physical uplink shared channel (PUSCH) or a physical uplink control channel (PUCCH) and an uplink reference signal from the signals subjected to these processes. Further, the reception processing unit 212 demodulates the reception signal using a modulation method such as binary phase shift keying (BPSK) or quadrature phase shift keying (QPSK) with respect to a modulation symbol of the uplink channel. The modulation method used for demodulation may be 16 quadrature amplitude modulation (QAM), 64 QAM, or 256 QAM. In this case, signal points on a constellation do not necessarily have to be equidistant. The constellation may be a non-uniform constellation (NUC). Then, the reception processing unit 212 performs a decoding process on the demodulated encoded bits of the uplink channel. The decoded uplink data and uplink control information are output to the control unit 23.

The antenna 213 is an antenna device (antenna unit) that mutually converts a current and a radio wave. The antenna 213 may include one antenna element (for example, one patch antenna) or may include a plurality of antenna elements (for example, a plurality of patch antennas). In a case where the antenna 213 includes a plurality of antenna elements, the wireless communication unit 21 may be configured to be beamformable. For example, the wireless communication unit 21 may be configured to generate a directional beam by controlling the directivity of a wireless signal using a plurality of antenna elements. Note that the antenna 213 may be a dual-polarized antenna. In a case where the antenna 213 is a dual-polarized antenna, the wireless communication unit 21 may use vertically polarized waves (V-polarized waves) and horizontally polarized waves (H-polarized waves) in transmitting wireless signals. Then, the wireless communication unit 21 may control the directivity of the wireless signal transmitted using the vertically polarized wave and the horizontally polarized wave. In addition, the wireless communication unit 21 may transmit and receive spatially multiplexed signals via a plurality of layers including a plurality of antenna elements.

The storage unit 22 is a storage means capable of reading and writing data, such as a DRAM, an SRAM, a flash memory, or a hard disk. The storage unit 22 functions as a storage unit of the base station 20.

The control unit 23 is a controller that controls each unit of the base station 20. The control unit 23 is implemented by, for example, a processor such as a central processing unit (CPU) or a micro processing unit (MPU). For example, the control unit 23 is implemented by a processor executing various programs stored in a storage device inside the base station 20 using a random access memory (RAM) or the like as a work area. Note that the control unit 23 may be implemented by an integrated circuit such as an application specific integrated circuit (ASIC) or a field programmable gate array (FPGA). Any of the CPU, the MPU, the ASIC, and the FPGA can be regarded as a controller. Further, the control unit 23 may be implemented by a graphics processing unit (GPU) in addition to or instead of the CPU.

In some embodiments, the concept of a base station may include a collection of multiple physical or logical devices. For example, in the present embodiment, the base station may be distinguished into a plurality of devices such as a baseband unit (BBU) and a radio unit (RU). Then, the base station may be interpreted as an assembly of the plurality of devices. In addition, the base station may be either or both of the BBU and the RU. The BBU and the RU may be connected by a predetermined interface (for example, enhanced Common Public Radio Interface (eCPRI)). Note that the RU may be referred to as a remote radio unit (RRU) or a radio dot (RD). In addition, the RU may correspond to a gNB Distributed Unit (gNB-DU) described later. Further, the BBU may correspond to a gNB Central Unit (gNB-CU) described below. Alternatively, the RU may be a wireless device connected to a gNB-DU described later. The gNB-CU, the gNB-DU, and the RU connected to the gNB-DU may be configured to conform to an open radio access network (O-RAN). Furthermore, the RU may be a device integrally formed with the antenna. An antenna (for example, an antenna integrally formed with an RU) included in the base station may adopt an Advanced Antenna System and support MIMO (for example, FD-MIMO) or beamforming. In addition, the antenna included in the base station may include, for example, 64 transmission antenna ports and 64 reception antenna ports.

In addition, the antenna mounted on the RU may be an antenna panel including one or more antenna elements, and the RU may be mounted with one or more antenna panels. For example, the RU may be mounted with two types of antenna panels of a horizontally polarized antenna panel and a vertically polarized antenna panel, or two types of antenna panels of a clockwise circularly polarized antenna panel and a counterclockwise circularly polarized antenna panel. In addition, the RU may form and control an independent beam for each antenna panel.

Note that a plurality of base stations may be connected to each other. The one or more base stations may be included in a radio access network (RAN). In this case, the base station may be simply referred to as a RAN, a RAN node, an access network (AN), or an AN node. Note that the RAN in LTE is sometimes referred to as an enhanced universal terrestrial RAN (EUTRAN). In addition, RAN in the NR may be referred to as an NGRAN. Further, RAN in W-CDMA (UMTS) is sometimes referred to as UTRAN.

Note that an LTE base station may be referred to as an evolved node B (eNodeB) or an eNB. At this time, the EUTRAN includes one or more eNodeBs (eNBs). In addition, an NR base station may be referred to as a gNodeB or a gNB. At this time, the NGRAN includes one or more gNBs. The EUTRAN may include a gNB (en-gNB) connected to a core network (EPC) in an LTE communication system (EPS). Similarly, the NGRAN may include an ng-eNB connected to a core network 5GC in a 5G communications system (5GS).

Note that, in a case where the base station is an eNB, a gNB, or the like, the base station may be referred to as 3GPP access. In addition, in a case where the base station is a wireless access point, the base station may be referred to as non-3GPP access. Furthermore, the base station may be an optical extension device called a remote radio head (RRH) or a radio unit (RU). In addition, in a case where the base station is a gNB, the base station may be a combination of the gNB-CU and the gNB-DU described above, or may be any one of the gNB-CU and the gNB-DU.

Here, the gNB-CU hosts a plurality of upper layers (for example, Radio Resource Control (RRC), Service Data Adaptation Protocol (SDAP), and Packet Data Convergence Protocol (PDCP)) in an access stratum for communication with the UE. On the other hand, the gNB-DU hosts a plurality of lower layers (for example, radio link control (RLC), medium access control (MAC), and physical layer (PHY)) in the access stratum. That is, among messages/information to be described later, RRC signaling (semi-static notification) may be generated by the gNB-CU, while MAC CE and DCI (dynamic notification) may be generated by the gNB-DU. Alternatively, in the RRC configuration (semi-static notification), for example, some configurations such as IE: cell group Config may be generated by the gNB-DU, and the remaining configurations may be generated by the gNB-CU. These configurations may be transmitted and received through an F1 interface described later.

Note that the base station may be configured to be able to communicate with another base station. For example, in a case where a plurality of base stations is eNBs or a combination of an eNB and an en-gNB, the base stations may be connected by an X2 interface. In addition, in a case where a plurality of base stations is gNBs or a combination of a gn-eNB and a gNB, the devices may be connected by an Xn interface. Further, in a case where a plurality of base stations is a combination of the gNB-CU and the gNB-DU, the devices may be connected by the above-described F1 interface. A message/information (for example, RRC signaling, MAC control element (MAC CE), or DCI) to be described later may be transmitted between a plurality of base stations, for example, via the X2 interface, the Xn interface, or the F1 interface.

A cell provided by the base station may be referred to as a serving cell. The concept of the serving cell includes a primary cell (PCell) and a secondary cell (SCell). In a case where dual connectivity is set in the UE (for example, the terminal device 30), the PCell provided by the MN (Master Node) and zero or one or more SCells may be referred to as a master cell group (Master Cell group). Examples of dual connectivity include EUTRA-EUTRA Dual Connectivity, EUTRA-NR Dual Connectivity (ENDC), EUTRA-NR Dual Connectivity with 5GC, NR-EUTRA Dual Connectivity (NEDC), and NR-NR Dual Connectivity.

Note that the serving cell may include a Primary Secondary Cell or Primary SCG Cell (PSCell). In a case where dual connectivity is set in the UE, the PSCell provided by the SN (Secondary Node) and zero or one or more SCells may be referred to as Secondary Cell Group (SCG). Unless specially configured (for example, PUCCH on SCell), the physical uplink control channel (PUCCH) is transmitted in the PCell and the PSCell, but is not transmitted in the SCell. Further, a radio link failure is also detected in the PCell and the PSCell, but is not detected (may not be detected) in the SCell. As described above, since the PCell and the PSCell have a special role in the serving cell, they are also referred to as a special cell (SpCell).

One downlink component carrier and one uplink component carrier may be associated with one cell. In addition, a system bandwidth corresponding to one cell may be divided into a plurality of bandwidth parts (BWPs). In this case, one or more BWPs may be set for the UE, and one BWP may be used for the UE as an active BWP (Active BWP). In addition, radio resources (for example, a frequency band, a numerology (subcarrier spacing), and a slot format (slot configuration)) that can be used by the terminal device 30 may be different for each cell, each component carrier, or each BWP.

### 2-4. Configuration Example of Terminal Device

Next, a configuration of the terminal device 30 will be described. The terminal device 30 can be rephrased as user equipment (UE) 30.

The terminal device 30 is a wireless communication device that wirelessly communicates with other communication devices such as the base station 20. The terminal device 30 is, for example, a mobile phone, a smart device (Smartphone or tablet), a personal digital assistant (PDA), or a personal computer. Further, the terminal device 30 may be a device such as a business camera provided with a communication function, or may be a motorcycle, a moving relay vehicle, or the like on which a communication device such as a field pickup unit (FPU) is mounted. In addition, the terminal device 30 may be a machine to machine (M2M) device or an Internet of Things (IoT) device.

Note that the terminal device 30 may be able to perform the NOMA communication with the base station 20. In addition, the terminal device 30 may be able to use an automatic retransmission technology such as HARQ when communicating with the base station 20. The terminal device 30 may be capable of sidelink communication with another terminal device 30. The terminal device 30 may be capable of using an automatic retransmission technology such as HARQ when performing sidelink communication. Note that the terminal device 30 may also be capable of the NOMA communication in communication (sidelink) with other terminal devices 30. In addition, the terminal device 30 may be able to perform LPWA communication with another communication device (for example, the base station 20 and another terminal device 30). Further, the wireless communication used by the terminal device 30 may be wireless communication using millimeter waves. Note that the wireless communication (including sidelink communication) used by the terminal device 30 may be wireless communication using radio waves or wireless communication (optical wireless) using infrared rays or visible light.

In addition, the terminal device 30 may be a mobile device. The mobile device is a movable wireless communication device. At this time, the terminal device 30 may be a wireless communication device installed in a mobile object or may be a mobile object itself. For example, the terminal device 30 may be a vehicle that moves on a road such as an automobile, a bus, a truck, or a motorcycle, a vehicle that moves on a rail installed on a track such as a train, or a wireless communication device mounted on the vehicle. Note that the mobile object may be a mobile terminal, or may be a mobile object that moves on land (on the ground in a narrow sense), underground, on water, or under water. In addition, the mobile object may be a mobile object that moves inside the atmosphere, such as a drone or a helicopter, or may be a mobile object that moves outside the atmosphere, such as an artificial satellite.

The terminal device 30 may be simultaneously connected to a plurality of base stations or a plurality of cells to perform communication. For example, in a case where one base station supports a communication area via a plurality of cells (for example, pCell and sCell), it is possible to bundle the plurality of cells and communicate between the base station 20 and the terminal device 30 by a carrier aggregation (CA) technology, a dual connectivity (DC) technology, or a multi-connectivity (MC) technology. Alternatively, the terminal device 30 and the plurality of base stations 20 can communicate with each other by a coordinated transmission and reception (coordinated multi-point transmission and reception (CoMP)) technology via cells of different base stations 20.

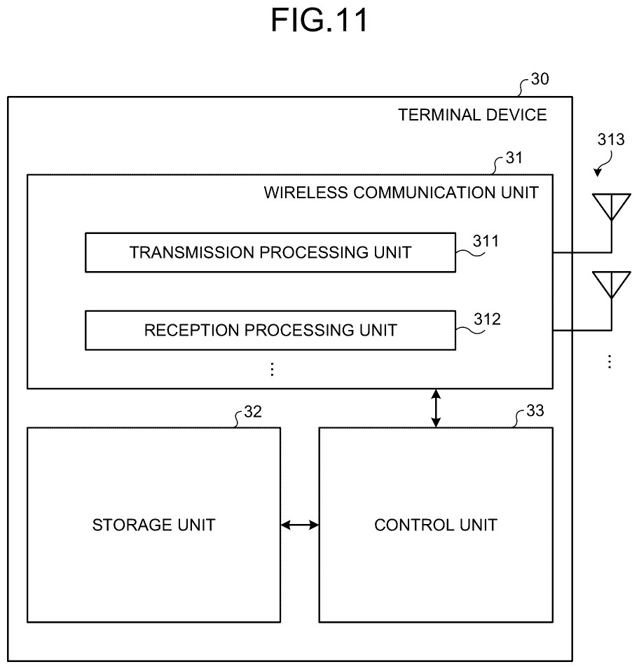

FIG. 11 is a diagram illustrating a configuration example of the terminal device 30 according to the embodiment of the present disclosure. The terminal device 30 includes a wireless communication unit 31, a storage unit 32, and a control unit 33. Note that the configuration illustrated in FIG. 11 is a functional configuration, and the hardware configuration may be different from the functional configuration. In addition, the functions of the terminal device 30 may be implemented in a distributed manner in a plurality of physically separated configurations.

The wireless communication unit 31 is a signal processing unit for wirelessly communicating with other wireless communication devices (for example, the base station 20 and another terminal device 30). The wireless communication unit 31 operates under the control of the control unit 33. The wireless communication unit 31 includes a transmission processing unit 311, a reception processing unit 312, and an antenna 313. The configurations of the wireless communication unit 31, the transmission processing unit 311, the reception processing unit 312, and the antenna 313 may be similar to those of the wireless communication unit 21, the transmission processing unit 211, the reception processing unit 212, and the antenna 213 of the base station 20. In addition, the wireless communication unit 31 may be configured to be beamformable similarly to the wireless communication unit 21. Furthermore, the wireless communication unit 31 may be configured to be able to transmit and receive spatially multiplexed signals similarly to the wireless communication unit 21.

The storage unit 32 is a storage device capable of reading and writing data, such as a DRAM, an SRAM, a flash memory, or a hard disk. The storage unit 32 functions as a storage means of the terminal device 30.

The control unit 33 is a controller that controls each unit of the terminal device 30. The control unit 33 is implemented by, for example, a processor such as a CPU or an MPU. For example, the control unit 33 is implemented by a processor executing various programs stored in a storage device inside the terminal device 30 using a RAM or the like as a work area. Note that the control unit 33 may be implemented by an integrated circuit such as an ASIC or an FPGA. Any of the CPU, the MPU, the ASIC, and the FPGA can be regarded as a controller. Further, the control unit 33 may be implemented by a GPU in addition to or instead of the CPU.

### 3. NETWORK ARCHITECTURE

While the configuration of the communication system 1 has been described above, a network architecture applicable to the communication system 1 of the present embodiment will be described next. An architecture of a fifth generation mobile communication system (5G) will be described below as an example of a core network of the communication system 1.

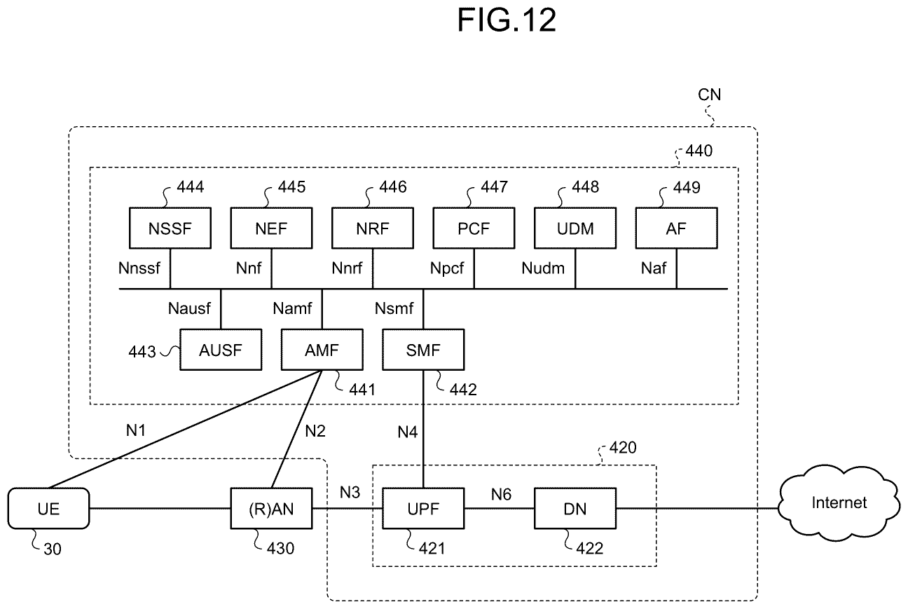

FIG. 12 is a diagram illustrating an example of 5G architecture. The 5G core network CN is also referred to as 5G Core (5GC)/Next Generation Core (NGC). Hereinafter, the 5G core network CN is also referred to as 5GC/NGC. The core network CN is connected to the user equipment (UE) 30 via a (R)AN 430. The UE 30 is, for example, the terminal device 30.

The (R)AN 430 has a function of enabling connection to a radio access network (RAN) and connection to an access network (AN) other than the RAN. The (R)AN 430 includes a base station called a gNB or an ng-eNB.

The core network CN mainly performs connection permission and session management when the UE 30 is connected to the network. The core network CN may include a user plane function group 420 and a control plane function group 440.

The user plane function group 420 includes a user plane function (UPF) 421 and a data network (DN) 422. The UPF 421 has a function of user plane processing. The UPF 421 includes a routing/forwarding function of data handled in a user plane. The DN 422 has a function of providing, for example, an entity that provides a connection to a unique service of an operator such as a mobile network operator (MNO), providing an Internet connection, or providing a connection to a third party service. As described above, the user plane function group 420 plays a role of a gateway serving as a boundary between the core network CN and the Internet.

The control plane function group 440 includes an access management function (AMF) 441, a session management function (SMF) 442, an authentication server function (AUSF) 443, a network slice selection function (NSSF) 444, a network exposure function (NEF) 445, a network repository function (NRF) 446, a policy control function (PCF) 447, a unified data management (UDM) 448, and an application function (AF) 449.

The AMF 441 has functions such as registration processing, connection management, and mobility management of the UE 30. The SMF 442 has functions such as session management and IP assignment and management of the UE 30. The AUSF 443 has an authentication function. The NSSF 444 has a function related to selection of a network slice. The NEF 445 has a function of providing network function capabilities and events to a third party, the AF 449, and edge computing functions.

The NRF 446 has a function of finding a network function and holding a profile of the network function. The PCF 447 has a function of policy control. The UDM 448 has functions of generating 3GPP AKA authentication information and processing a user ID. The AF 449 has a function of interacting with the core network to provide a service.

For example, the control plane function group 440 acquires information from the UDM 448 in which subscriber information of the UE 30 is stored, and determines whether or not the UE 30 may connect to the network. The control plane function group 440 uses contract information of the UE 30 and a key for encryption included in the information acquired from the UDM 448 for such determination. Further, the control plane function group 440 generates a key for encryption and the like.

That is, the control plane function group 440 determines whether or not the network can be connected according to whether or not information of the UE 30 associated with a subscriber number called international mobile subscriber identity (IMSI) is stored in the UDM 448, for example. Note that the IMSI is stored in, for example, a subscriber identity module (SIM) card in the UE 30.

Here, Namf is a service-based interface provided by the AMF 441, and Nsmf is a service-based interface provided by the SMF 442. Further, Nnef is a service-based interface provided by the NEF 445, and Npcf is a service-based interface provided by the PCF 447. Nudm is a service-based interface provided by the UDM 448, and Naf is a service-based interface provided by the AF 449. Nnrf is a service-based interface provided by the NRF 446, and Nnssf is a service-based interface provided by the NSSF 444. Nausf is a service-based interface provided by the AUSF 443. Each of these network functions (NFs) exchanges information with another NF via each service-based interface.

Further, N1 illustrated in FIG. 12 is a reference point between the UE 30 and the AMF 441, and N2 is a reference point between the RAN/AN 430 and the AMF 441. N4 is a reference point between the SMF 442 and the UPF 421, and information is exchanged between these network functions (NFs).

As described above, in the core network CN, an interface for transmitting information and controlling functions via an application programming interface (API) called a service-based interface is prepared.

The API designates a resource and enables GET (acquisition of resource), POST (creation of resource and addition of data), PUT (creation of resource and update of resource), DELETE (deletion of resource), and the like for the resource. Such a function is generally used, for example, in the technical field related to the Web.

For example, the AMF 441, the SMF 442, and the UDM 448 illustrated in FIG. 12 exchange information with each other using the API in a case of establishing a communication session. Conventionally, it is not assumed that an application (for example, AF 449) uses such an API. However, when the AF 449 uses such an API, the AF 449 can use information of a 5G cellular network, and it is considered that a function of an application can be further evolved.

Note that it is difficult for the AF 289 to use the API used by the AMF 441, the SMF 442, and the UDM 448 in a public network. However, in the case of a non public private 5G network, it is considered that the system can be configured including, for example, a change in the API of the core network CN so that the AF 289 can use such an API.

Here, an example of the API will be described. API(1) to API(4) described here are described in 3GPP TS 23.502.

### API(1)

The API(1) is an API by which the SMF 442 provides a notification that the UE 30 registered in advance transitions from a power off state to a power on state and attaches to the network, and provides a notification of an IP address acquired at that time.

The SMF 442 uses the API (1) to notify the NF when the UE 30 of the registered IMSI obtains the IP address.

### API(2)

The UE 30 enters an Idle mode when not communicating, and transitions to a Connected mode when communicating. The API (2) is an API in which the AMF 441 provides a notification as to whether the UE 30 is in the Idle mode or the Connected mode.

### API(3)

The API (3) is an API for broadcasting a message (Paging message) for instructing the UE 30 to transition from the Idle mode to the Connected mode from the base station.

### API(4)

The API (4) is an API in which the AMF 441 provides the position information of the UE 30. The AMF 441 may use the API (4) to inform which Tracking Area the UE 30 is in, which Cell it belongs to, and when it enters a specific region.

Note that an example of the UE 30 in FIG. 12 is the terminal device 30 of the present embodiment. An example of the PAN/AN 430 is the base station 20 of the present embodiment. Further, the management device 10 illustrated in FIG. 9 is an example of a device having a function of, for example, the AF 449 or the AMF 441.

### 4. FIRST EMBODIMENT

While the configuration of the communication system 1 has been described above, the operation of the communication system 1 having such a configuration will be described next.

### 4-1. Problem

Conventionally, even in a case of handling a plurality of BWPs, a communication device (for example, the management device 10, the base station 20, or the terminal device 30) individually controls each BWP instead of grouping and controlling the plurality of BWPs. For example, the base station 20 measures the time during which the terminal device 30 does not use the BWP by each of the plurality of BWPs, and when the non-use time reaches a certain time, switches only the BWP reaching the certain time to the default BWP. Further, when the base station 20 actively switches the BWP, the base station 20 switches only one BWP to another BWP using downlink control information (DCI).

However, with the diversification of communication services, it is assumed that a plurality of network slices, that is, BWPs will be dependent on one service in the future. In this case, it is not possible to efficiently perform the switch of the BWP or the return to the default BWP only by a mechanism that handles individual BWPs as in the related art. Although it is necessary to group and control a plurality of BWPs, it is necessary to newly develop which function should perform grouping of BWPs, what is the procedure for that, a method of a switch after grouping, a trigger condition for default regression, and the like.

In a case where a plurality of network slices is used in one service, it is assumed that the terminal device 30 or an application mounted in an application function on the core network side determines how many network slices are necessary for one service. At that time, it is assumed that the terminal device 30 or the application also determines a parameter (for example, the subcarrier spacing required for the network slice) that determines the property of each network slice. Conventionally, when the terminal device 30 establishes a session, the terminal device 30 notifies a network side which network slice is desired. Single Network Slice Selection Assistance Information (S-NSSAI) is used at that time.

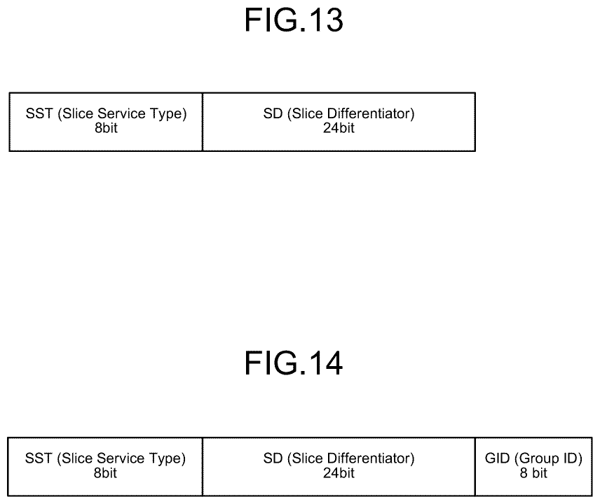

FIG. 13 is a diagram illustrating a configuration of conventional S-NSSAI. Conventionally, the UE transmits S-NSSAI in a format as illustrated in FIG. 13 to a network slice selection function (NSSF) of the core network. In FIG. 13, Slice Service Type (SST) represents a property of a network slice such as eMBB or URLLC. Slice differentiators (SDs) are used for differentiation within SSTs such as eMBB. The NSSF of the core network prepares a network slice used by the terminal device 30 on the basis of the S-NSSAI. The base station 20 prepares a BWP as a network slice on the RAN side. The base station 20 notifies the terminal device 30 of setting information by RRC signaling so that the terminal device 30 can use the BWP.

In a case where the terminal device 30 desires to use a plurality of network slices, requests are individually made using the S-NSSAI, and network slices are individually allocated. At this time, there is no relationship between the BWPs corresponding to the respective network slices, and the respective BWPs are treated as independent. Originally, the network slice should be handled independently, but in a case where a plurality of BWPs is allocated for one service, it is more efficient from the viewpoint of signaling efficiency and securing resources that the plurality of BWPs operate in cooperation.

### 4-2. Solution

Accordingly, in the present embodiment, in a case where a plurality of BWPs corresponding to the S-NSSAI is set, the terminal device 30 notifies the NSSF that the BWPs are treated as a group.

FIG. 14 is a diagram illustrating a configuration example of the S-NSSAI of the present embodiment. In the present embodiment, a group ID (GID) is added after the conventional SST and SD. By setting the GID of the S-NSSAI treated as a group to the same value, a plurality of BWPs corresponding to the plurality of pieces of the S-NSSAI is associated with each other. Different SSTs can also belong to one group ID. Multiple identical SSTs can be treated as a group, or multiple different SSTs can be treated as an identical group.

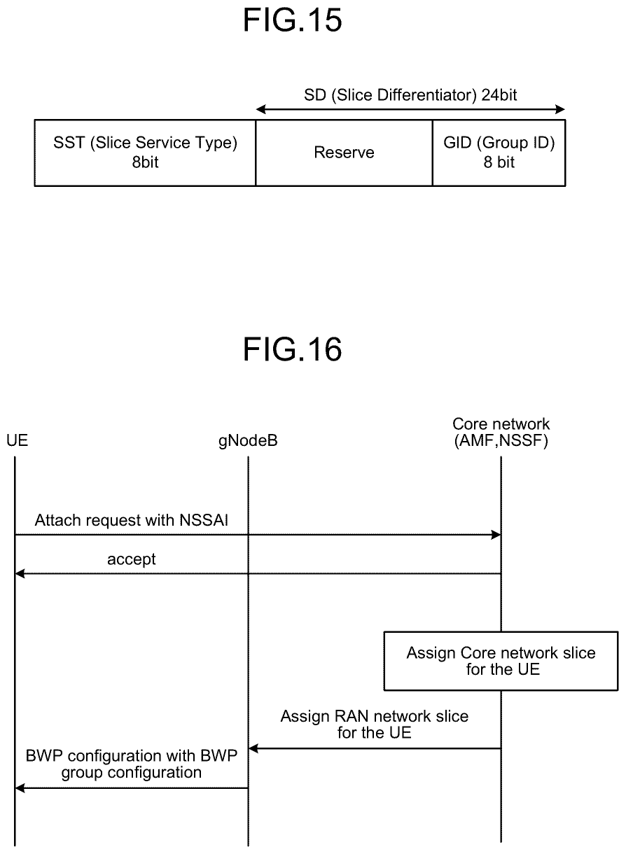

FIG. 15 is a diagram illustrating another configuration example of the S-NSSAI of the present embodiment. In the example of FIG. 15, GID is defined in a conventional Slice Differentiator (SD). The SD is originally a region used to distinguish objects in the same SST, but the use of the SD for the purpose of clearly indicating which service the SD belongs to does not deviate from the original purpose. Thus, it also makes sense to define the GID in this SD.

In the case of the use case of FIG. 6, each of the UE A and the UE B needs to send a message in the format illustrated in FIG. 14 or 15 to the core network. In the example of FIG. 6, there are two combinations of eMBB and URLLC. In a case where all of them are handled as a group, the terminal device 30 transmits a message in the format illustrated in FIG. 14 or 15 to the core network 4 times. In this case, the messages all have the same GID. In a case where there are two sets of combinations of eMBB and URLLC, and each set is regarded as one service, the first eMBB and URLLC are associated with the first GID. The second eMBB and URLLC are associated with the second GID.

The use case of FIG. 7 is a case where one UE A exchanges signals with many UEs B. In a case where many signal exchanges are considered to belong to one service, the UE A can associate all of a plurality of URLLCs with one GID. On the other hand, the UE B associates two slices of uplink (UL) and downlink (DL) URLLC with one GID.

FIG. 16 is a sequence diagram illustrating an operation of grouping and setting a plurality of network slices. In order to group and set a plurality of network slices, first, the terminal device 30 sends a request as illustrated in FIG. 14 or 15 to the core network. The core network determines whether or not it is possible to respond to a network slice use request and a grouping request from the terminal device 30. In a case where it is possible to respond to the request, the core network performs various settings so that the terminal device 30 can use the network slice on the core network side and the network slice on the PAN side via the base station 20. For example, the core network notifies the base station 20 that the plurality of grouped network slices is allocated to the terminal device 30. The base station 20 generates setting information for the terminal device 30 on the basis of information from the core network. The setting information is information for setting a plurality of BWPs as one BWP group for one service. The base station 20 sets the BWP for the terminal device 30 using the setting information.

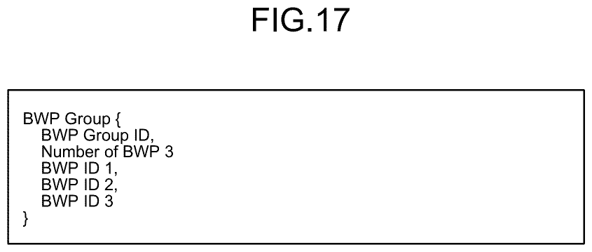

When setting the BWP as the network slice on the PAN side, the base station 20 notifies the terminal device 30 that a plurality of BWPs is grouped. At that time, the base station 20 may provide a notification that the plurality of BWPs is grouped as the setting information (for example, the RRC configuration). FIG. 17 is a diagram illustrating an example of setting information indicating that a plurality of BWPs is grouped. The example of FIG. 17 illustrates that three BWPs are grouped. The constituent elements of the group are designated by the BWP ID. For the definition of the BWP itself, for example, the subcarrier spacing, the used frequency, and the like are defined by the setting of the BWP itself.

At this time, at least one of the plurality of BWPs included in the BWP group may have a subcarrier spacing different from other BWPs in the BWP group. It is possible to efficiently cope with diversification of services.

According to the present solution, a plurality of BWPs can be set for the terminal device 30 as a group. Since different SSTs can be handled simultaneously as a group, or the like, it is possible to reduce signaling between the terminal device 30 and the base station 20.

### 5. SECOND EMBODIMENT

Next, an operation of the communication system 1 of a second embodiment will be described.

### 5-1. Problem

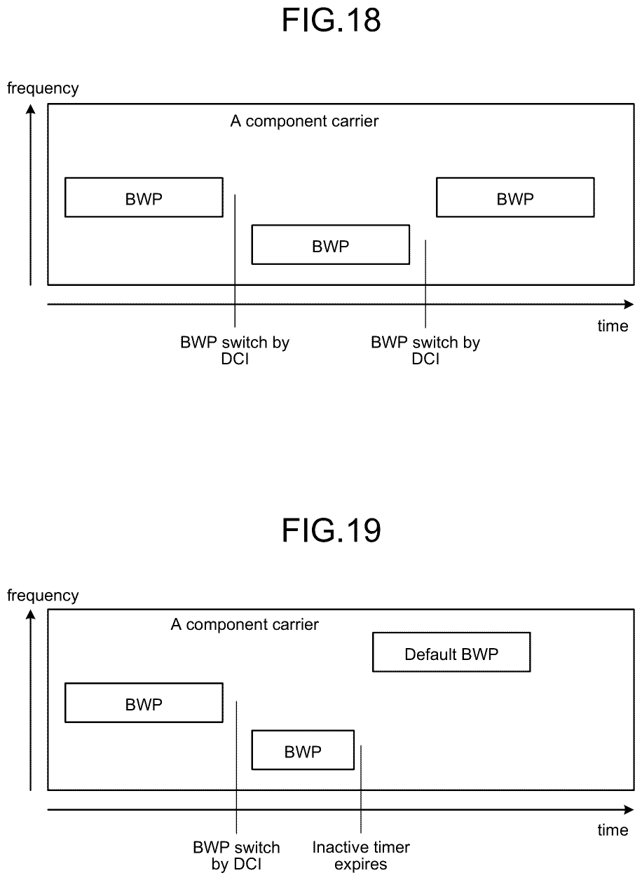

A switch of the BWP used by the terminal device 30 can be statically set by RRC signaling, or can be dynamically changed. In this case, a downlink control indication (DCI) of a PHY downlink control channel (PDCCH) is transmitted from the base station 20 to the terminal device 30, so that the BWP can be dynamically switched. FIG. 18 is a diagram for describing a method of switching the BWP using DCI. At this time, the BWP ID is used to designate the BWP of the switch destination. In many cases, the BWP ID of the switch destination is designated in the DCI in the PDCCH in the BWP of the switch source.

As a BWP switching method, there is a switching method using an inactive timer in addition to the switching method using DCI. FIG. 19 is a diagram for describing a method of switching the BWP using an inactive timer. First, the communication device (the base station 20 and the terminal device 30) sets the inactive timer. Upon detecting that the BWP is not used in the inactive timer, the communication device switches to the default BWP (typically, a BWP called an initial BWP used at the time of initial access is used). The switch using the inactive timer is also a technique related to switching of one BWP.

From the problem of ease of manufacturing the terminal device 30, a case where the number of BWPs that can be simultaneously handled by one component carrier (CC) by the terminal device 30 is only one is important. Normally, in a case where the terminal device 30 uses a plurality of BWPs, the terminal device 30 frequently switches the BWP. That is, although there is one BWP that can be used at the same time, the terminal device 30 can use a plurality of BWPs by the switch of the BWP.

In this case, the base station 20 designates the next BWP ID in the DCI transmitted using one BWP. By repeating this, the BWP is sequentially switched. For example, in a case where BWP ID=1->BWP ID=2->BWP ID=3->BWP ID=1 is repeated, the base station 20 designates the BWP ID in each DCI. However, this is extremely complicated.

### 5-2. Solution

Accordingly, in the present embodiment, the base station 20 transmits pattern information in which a switching pattern of the BWP is written to the terminal device 30 in advance. The transmission of the pattern information is performed semi-statically by RRC signaling, for example. That is, the base station 20 semi-statically sets a switching schedule for the terminal device 30. The terminal device 30 switches the BWP according to the pattern information.

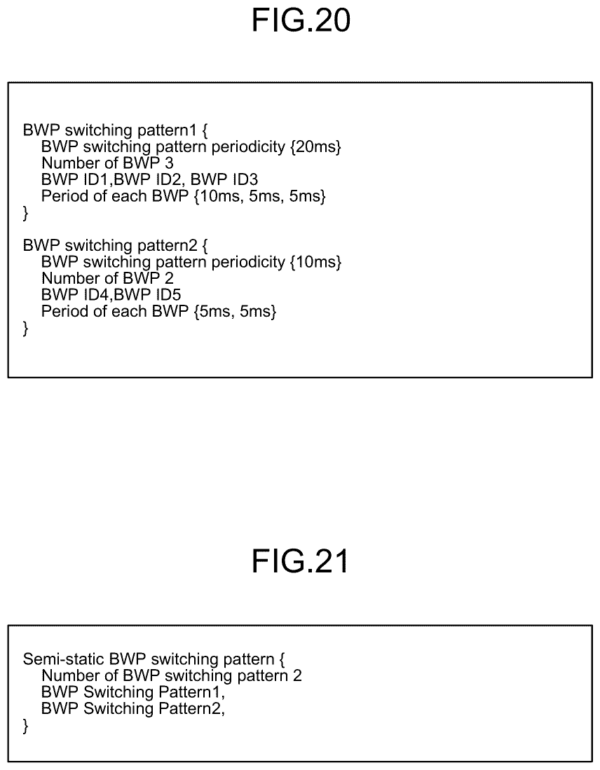

FIG. 20 is a diagram illustrating a definition example of the pattern information. In FIG. 20, two pieces of pattern information of BWP switching pattern 1 and BWP switching pattern 2 are defined. In the BWP switching pattern 1 and the BWP switching pattern 2, switching patterns of BWPs in different BWP groups are described. In the pattern information, for example, the duration of the entire switching pattern, the number of BWPs to be switched, and continuous use of each of the BWPs are described. In the case of BWP switching pattern 1, the duration of the entire switching pattern is 20 ms, the number of BWPs to switch is 3, and the continuous use of three BWPs is 10 ms, 5 ms, and 5 ms, respectively. The three BWPs are a BWP group. Further, in the case of the BWP switching pattern 2, the duration of the entire switching pattern is 10 ms, the number of BWPs to be switched is 2, and the continuous use of the two BWPs is 5 ms and 5 ms, respectively. The two BWPs are a BWP group.

The base station 20 sets the pattern information defined as described above in the terminal device 30. FIG. 21 is a diagram illustrating a setting example of pattern information. In the example of FIG. 21, the above-described BWP switching pattern 1 and BWP switching pattern 2 are set in the terminal device 30. Note that the base station 20 may perform switching of the BWP switching pattern by dynamic notification (for example, DCI). In a case where there is no pattern switching instruction by dynamic notification, the terminal device 30 may repeat one pattern.

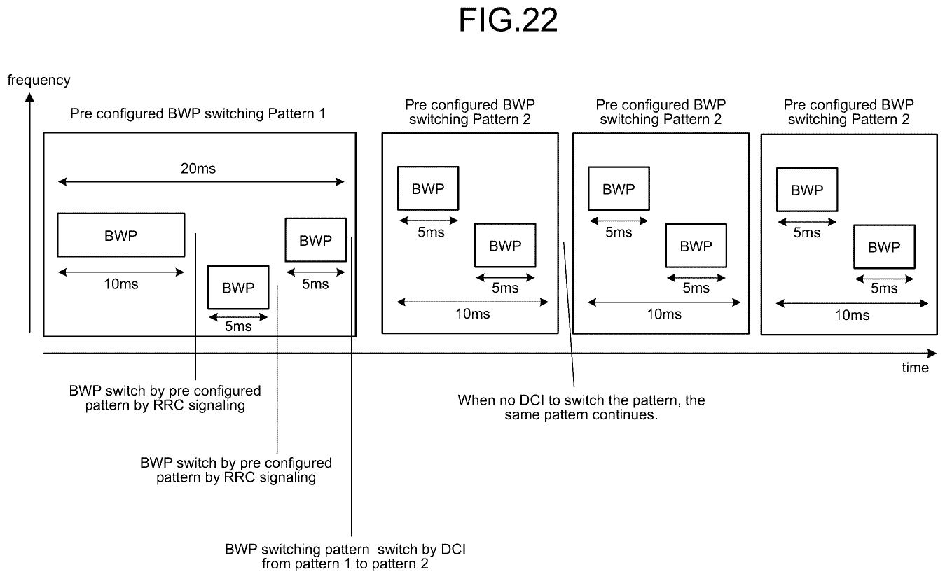

FIG. 22 is a diagram illustrating an operation example in the setting example illustrated in FIG. 21. In the example of FIG. 22, the BWP switching pattern 1 and the BWP switching pattern 2 are switched by DCI, and thereafter, the BWP switching pattern 2 is repeated. In the example of FIG. 22, the base station 20 gives an instruction to switch the BWP switching pattern by using the DCI, but may give an instruction to switch the BWP switching pattern by using normal RRC signaling.

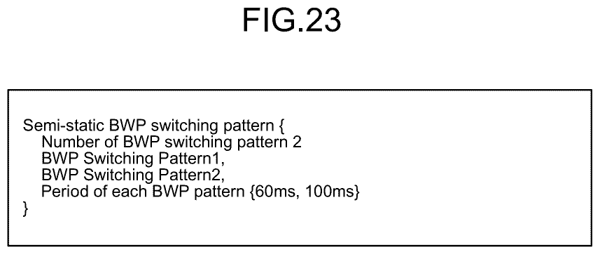

In addition, the base station 20 may set a method of switching the BWP switching pattern to semi-static by RRC configuration for the terminal device 30. FIG. 23 is a diagram illustrating a setting example of the method of switching the BWP switching pattern. The setting example of FIG. 23 is obtained by adding the setting of the method of switching the BWP switching pattern to the setting example illustrated in FIG. 21. In the example of FIG. 23, the above-described BWP switching pattern 1 and BWP switching pattern 2 are set in the terminal device 30, and the switching method of the two BWP switching patterns is also set in the terminal device 30. In the example of FIG. 23, after BWP switching pattern 1 is repeated 3 times, switching pattern 2 is repeated 10 times. This is repeated endlessly thereafter.

Thus, the DCI is not required for switching a plurality of BWPs treated as a group. In addition, since BWP switching can be performed collectively for each group, signaling for switching is reduced. For example, in the example of FIG. 22, the BWP is switched 9 times. According to the conventional method, the base station 20 needs to instruct the terminal device 30 to switch 9 times using the DCI, but using the present solution, the DCI only needs to be performed once.

According to the present solution, a plurality of BWPs can be set for the terminal device 30 as a group. Since different SSTs can be handled as a group at the same time or the like, it is possible to reduce signaling between the terminal and the base station.

### 6. THIRD EMBODIMENT

Next, an operation of the communication system 1 of a third embodiment will be described.

### 6-1. Problem

Currently, even if a plurality of BWPs is set in one terminal device 30, the number of BWPs that can be simultaneously transmitted and received by the terminal device 30 is one. In the future, it is assumed that the terminal device 30 can simultaneously transmit and receive a plurality of BWPs. However, currently, even if one terminal device 30 can simultaneously transmit and receive a plurality of BWPs, there is no control method required in a case where the plurality of BWPs is treated as a group.

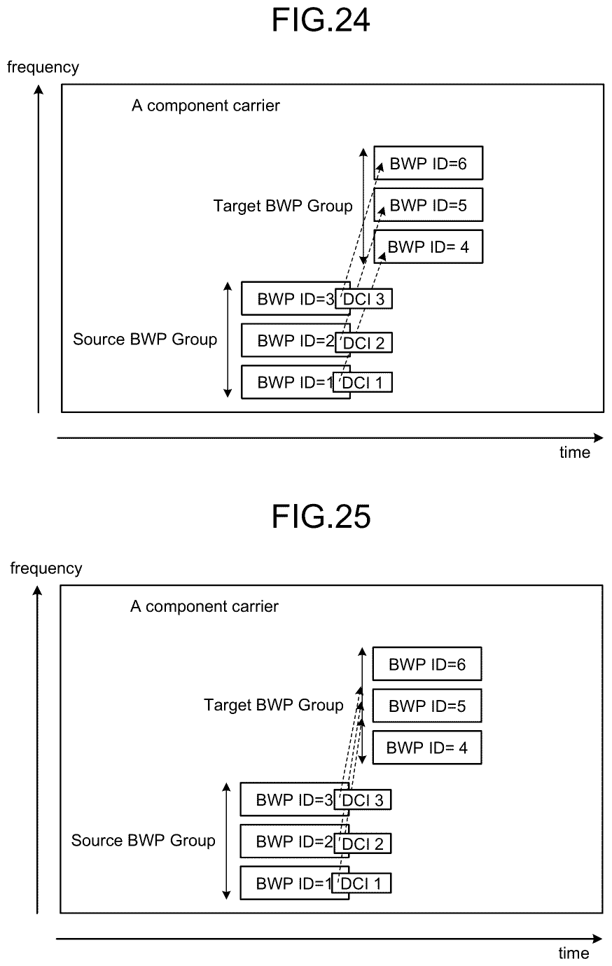

FIG. 24 is a diagram illustrating an example of a method of switching of a BWP group. When the conventional method is simply followed, the next BWP ID is simultaneously designated in the DCI of the PDCCH in each BWP. In the example of FIG. 24, the base station 20 switches the BWP with the BWP ID of 1 to the BWP with the BWP ID of 4 by using the content DCI 1 illustrated in Table 1 below. Further, in the example of FIG. 24, the base station 20 switches the BWP with the BWP ID of 2 to the BWP with the BWP ID of 5 by using the DCI 2 with the contents illustrated in Table 2 below. Furthermore, in the example of FIG. 24, the base station 20 switches the BWP with the BWP ID of 3 to the BWP with the BWP ID of 6 by using the DCI 3 with the contents illustrated in Table 3 below. However, this requires a lot of signaling, and the procedure is complicated.

TABLE 1
BWP Group Switching indication in DCI1

| | Source BWP | Target BWP |
|---|---|---|
| BWP ID | 1 | 4 |

TABLE 2
BWP Group Switching indication in DCI2

| | Source BWP | Target BWP |
|---|---|---|
| BWP ID | 2 | 5 |

TABLE 3
BWP Group Switching indication in DCI3

| | Source BWP | Target BWP |
|---|---|---|
| BWP ID | 3 | 6 |

A particular problem is a case where any of the switching by the plurality of DCIs fails. When any of the plurality of switches fails, the service using the plurality of BWPs cannot be used.

Further, in a case where the BWP of the switch destination is determined by each individual DCI, the timing of completion of the switch differs for each BWP. In this case, the base station 20 and the terminal device 30 need to wait for all the switches in the group to be completed in order to continue the service.

### 6-2. Solution 1

Accordingly, in the present embodiment, the base station 20 gives an instruction of switches of the plurality of BWPs included in the BWP group at the same timing. More specifically, the base station 20 designates a BWP as a switching destination of another grouped BWP in each of the plurality of BWPs. For example, a case of collectively switching from the source BWP group (BWP ID=1, BWP ID=2, and BWP ID=3) to the target BWP group (BWP ID=4, BWP ID=5, and BWP ID=6) is considered. In this case, three switching destination BWPs are also designated in the DCI of each of the three BWPs. In this way, even if reception of the DCI fails, if the reception of the DCI succeeds in any one of the BWPs, the switching as the BWP group succeeds.

Here, it is actually necessary to specify which BWP ID is to be switched to which BWP ID. This is because it is unknown whether the BWP with the BWP ID=1 is switched to the BWP with the BWP ID=4 or the BWP with the BWP ID=5. Therefore, in the present embodiment, the source BWP and the target BWP are designated in association with each other in each DCI as illustrated in the following Tables 4 to 6. Table 4 illustrates switching information designated in DCI in a BWP with a BWP ID of 1. Further, Table 5 illustrates switching information designated in DCI in a BWP with a BWP ID of 2. Furthermore, Table 6 illustrates switching information designated in DCI in a BWP with a BWP ID of 3. This makes it clear which BWP is switched to which BWP.

TABLE 4
BWP Group Switching indication in DCI1

| | Source BWP | Target BWP |
|---|---|---|
| BWP ID | 1 | 4 |
| BWP ID | 2 | 5 |
| BWP ID | 3 | 6 |

TABLE 5
BWP Group Switching indication in DCI2

| | Source BWP | Target BWP |
|---|---|---|
| BWP ID | 1 | 4 |
| BWP ID | 2 | 5 |
| BWP ID | 3 | 6 |

TABLE 6
BWP Group Switching indication in DCI3

| | Source BWP | Target BWP |
|---|---|---|
| BWP ID | 1 | 4 |
| BWP ID | 2 | 5 |
| BWP ID | 3 | 6 |

The order of the previously set BWP IDs may be stored in the terminal device 30, and information of the source BWP group may be omitted. However, it is more efficient that all information is complete in the DCI than to have the information inside the terminal device 30.

Note that the base station 20 may designate only the group ID instead of the above method. FIG. 25 is a diagram illustrating a method of switching a BWP group using a group ID. Tables 7 to 9 below illustrate switching information designated in each DCI. Table 7 illustrates switching information designated in DCI in a BWP with a BWP ID of 1. Further, Table 8 illustrates switching information designated in DCI in a BWP with a BWP ID of 2. Furthermore, Table 9 illustrates switching information designated in DCI in a BWP with a BWP ID of 3.

TABLE 7
BWP Group Switching indication in DCI1

| | Source BWP Group | Target BWP Group |
|---|---|---|
| BWP ID | 1 | 2 |

TABLE 8
BWP Group Switching indication in DCI2

| | Source BWP Group | Target BWP Group |
|---|---|---|
| BWP ID | 1 | 2 |

TABLE 9
BWP Group Switching indication in DCI3

| | Source BWP Group | Target BWP Group |
|---|---|---|
| BWP ID | 1 | 2 |

In the example of FIG. 25, a plurality of BWPs in the source BWP group and a plurality of BWPs in the target BWP group correspond to each other in order from the top. For example, it is assumed that a plurality of BWPs in the source BWP group is defined as BWP ID=1, BWP ID=2, and BWP ID=3 in order from the top, and a plurality of BWPs in the target BWP group is defined as BWP ID=4, BWP ID=5, and BWP ID=6 in order from the top. In this case, the BWP with the BWP ID=1 is switched to the BWP with the BWP ID=4, the BWP with the BWP ID=2 is switched to the BWP with the BWP ID=5, and the BWP with the BWP ID=3 is switched to the BWP with the BWP ID=5.

The operation of adding and deleting the BWP group is designated in the definition of the BWP group. The base station 20 transmits the definition of the BWP group to the terminal device 30 by RRC signaling. Thus, the base station 20 instructs the terminal device 30 to perform the operation of adding and deleting the BWP group.

According to the present solution, since the switching of the BWPs as the group is completed quickly, throughput is improved. Since the probability of the BWP switch due to reception failure of the DCI is reduced, the reliability of communication is improved.

### 6-3. Solution 2

In a case where the BWP is switched, a delay occurs from the start of switching to the completion of switching of the RF circuit (analog circuit). This delay is different for each subcarrier spacing. The slot length becomes shorter as the subcarrier spacing becomes longer, but in 5G, slots having slot lengths of 1 ms, 0.5 ms, 0.25 ms, and 0.125 ms are prepared. Table 10 is a diagram illustrating a correspondence between the slot length and the switch delay in 5G. In 5G, the number of slots required for switching is defined as one slot, two slots, three slots, and six slots, respectively, as illustrated in Table 10.

TABLE 10
TS38.133 BWP switch delay

| No. | NR slot length (ms) | BWP switch delay (slot) |
|---|---|---|
| 0 | 1 | 1 |
| 1 | 0.5 | 2 |
| 2 | 0.25 | 3 |
| 3 | 0.125 | 6 |

In a case where the BWPs are grouped, the use start time of the BWP group needs to match the use start time of the BWP in which the completion of the switch is the latest among the BWPs included in the BWP group. Accordingly, in a case where a plurality of BWPs included in the BWP group is switched to other BWPs, the communication device (the base station 20 and the terminal device 30) sets the latest switch completion timing among switch completion timings of the plurality of BWPs as a completion timing of switches of the plurality of BWPs.

At this time, in a case of receiving a switch instruction for each of the plurality of BWPs included in the BWP group, the terminal device 30 measures delays of switches of the plurality of BWPs from the timing of the last received instruction among a plurality of received instructions. For example, a case of switching the BWP group from the source BWP group (BWP ID=1, BWP ID=2, and BWP ID=3) to the target BWP group (BWP ID=4, BWP ID=5, and BWP ID=6) is considered. Here, it is assumed that the DCI for switching the BWPs is received in each of the three BWPs. At this time, when the DCI with the BWP ID=1 is received last among the three pieces of DCI, the terminal device 30 measures a delay of the switches of the three BWPs from the timing when the DCI with the BWP ID=1 is received.

In addition, in a case of receiving the switch instruction for each of the plurality of BWPs included in the BWP group, the terminal device 30 may determine the switch completion timing of each of the plurality of BWPs on the basis of the reception timing of the switch instruction of each of the plurality of BWPs and a switching delay of each of the plurality of BWPs, and determine the latest timing among the determined switch completion timings as a timing at which switches of the plurality of BWPs are completed.

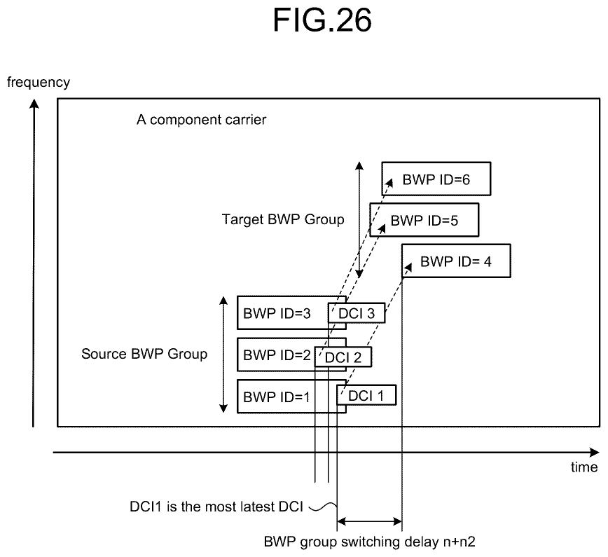

FIG. 26 is a diagram for describing a method of measuring the switch completion timing of the BWP group. FIG. 26 illustrates a state of switching from the source BWP group (BWP ID=1, BWP ID=2, and BWP ID=3) to the target BWP group=(BWP ID=4, BWP ID=5, and BWP ID=6). Here, the time of the DCI is n, and the switching delay of the BWP is n2. At this time, the terminal device 30 regards the timing when n+n2 is the largest as the time when the switching of the BWP groups is completed.

Note that, in the solution 1, the case where all the switching information of each of the plurality of BWPs is included in each of the plurality of DCIs has been described. Even in a case where all the switch information of each of the plurality of BWPs is included in each of the plurality of DCIs, it is also important which DCI is earlier. Therefore, also in this case, the switch completion timing is determined in the time of n+n2. On the other hand, in a case where only one piece of DCI is completely transmitted, the switch completion timing is determined only by n2.

According to the present solution, it is possible to accurately determine the switch completion timing.

### 7. FOURTH EMBODIMENT

Next, an operation of the communication system 1 of a fourth embodiment will be described.

### 7-1. Problem

As a BWP switching method, there is a switching method using an inactive timer. The communication device (the base station 20 and the terminal device 30) sets a timer called an inactive timer. The communication device observes a frequency status and a usage status of the BWP, and upon detecting that the BWP is not used for the time set in the timer (that is, when the inactive timer expires), the communication device switches to the default BWP (typically, an initial BWP) as illustrated in FIG. 19. In a case where the channel state of the BWP is poor, the terminal device 30 and the base station 20 may not be able to communicate. When not able to communicate, the terminal device 30 and the base station 20 can continue the communication by switching to the default BWP determined in advance.

However, in a case where a plurality of BWPs is grouped and used, if only one BWP in one BWP group is moved to the default BWP just because the inactive timer of the BWP group has expired, the service quality of the upper layer may be significantly impaired due to reasons such as not meeting the communication performance required by the service in the entire BWP group.

Further, in a case where the inactive timers of a plurality of BWPs in one BWP group expire, if the plurality of BWPs is switched to one default BWP, the communication performance required by the service is naturally not satisfied, and thus the service has to stop operating until the BWPs are switched again to the plurality of BWPs.

That is, in a case where a plurality of BWPs is used for one service, it is necessary to review the operation of the communication device when the inactive timer of one or a plurality of BWPs expires, in order to minimize the influence on the upper-layer service.

### 7-2. Solution

Accordingly, the communication device (the base station 20 and the terminal device 30) of the present embodiment sets the inactive timer for each of the plurality of BWPs of the BWP group. This is because it is necessary to view the state of each BWP. As illustrated in Table 11 below, for example, the BWPs have the same property or different properties. In the example of Table 11, the BWPs 5 and 6 are for eMBB, the subcarrier spacing is 15 kHz, and the frame configuration is 1 slot/subframe. Further, the BWP 7 is for URLLC and has a subcarrier spacing of 30 kHz and a frame configuration of 1 slot/subframe.

TABLE 11
Property of BWP of constituent elements of BWP group

| | | Subcarrier spacing | |
|---|---|---|---|
| No. | use case | [kHz] | Frame structure |
| BWP ID = 5 | eMBB | 15 | 1slot/subframe |
| BWP ID = 6 | eMBB | 15 | 1slot/subframe |
| BWP ID = 7 | URLLC | 30 | 2slot/subframe |

In the present embodiment, the default BWP is set for each property of the BWP. For example, the BWP ID of the default BWP is set to a different value for each Slice Service Type (SST). For example, in the case of the BWP group in the state illustrated in Table 11, the default BWP is prepared as illustrated in Table 12 below.

TABLE 12
default value of BWP of constituent elements of BWP group

| | default |
|---|---|
| BWP ID = 5 | BWP ID = 1 |
| BWP ID = 6 | BWP ID = 1 |
| BWP ID = 7 | BWP ID = 2 |

Here, the states of the default BWPs (BWPs with BWP IDs of 1 and 2) are as illustrated in Table 13 below.

TABLE 13
Property of BWP of constituent elements of BWP group

| | | Subcarrier spacing | |
|---|---|---|---|
| | use case | [kHz] | Frame structure |
| Default BWP ID = 1 | eMBB | 15 | 1slot/subframe |
| Default BWP ID = 2 | URLLC | 30 | 2slot/subframe |

That is, one default BWP is prepared for eMBB, and another default BWP is prepared for URLLC. In this manner, the influence on the service is reduced as compared with a case where a plurality of BWPs is simply switched to one default BWP.

Note that it is conceivable that the base station 20 switches the BWP used by the terminal device 30 to another communicable BWP by using the DCI without setting the default value. However, when each of the base station 20 and the terminal device 30 detects an inactive state and then the base station 20 causes the BWP used by the terminal device 30 to switch to another BWP using the DCI, a large delay occurs. Furthermore, in the 3GPP release 15, in a case where the inactive timer expires, it is specified to move to the default BWP. In order to cope with a case where a plurality of BWPs is grouped without significantly changing this operation, it is better for the communication device to check the expire of the inactive timer in each BWP and move each BWP to the default BWP, in order to be consistent with the conventional standard. If not, the operation when the inactive timer expires greatly differs between the case where the BWP group is set and the case where the BWP group is not set, and thus it is desirable to adopt the above method.

Note that, among the plurality of BWPs belonging to the BWP group, it is desirable that the communication device continue to use the same BWP as it is for a BWP for which the inactive timer has not expired.

Note that it is conceivable that, even if the inactive timer expires, it may be better to leave the expired BWP without switching it to the default BWP. For example, it is assumed that there are two eMBB BWPs and three BWPs of URLLC in one BWP group. In this case, even if one of the BWPs of the URLLC expires, the communication device can continue communication using a BWP of another URLLC without switching the expired BWP to the default BWP. However, in this case, the communication device is only required to switch the expired BWP to the default BWP and then leave the BWP as it is. In addition, the communication device may delete the ID of the BWP from the definition of the BWP group by RRC signaling after switching the expired BWP to the default BWP.

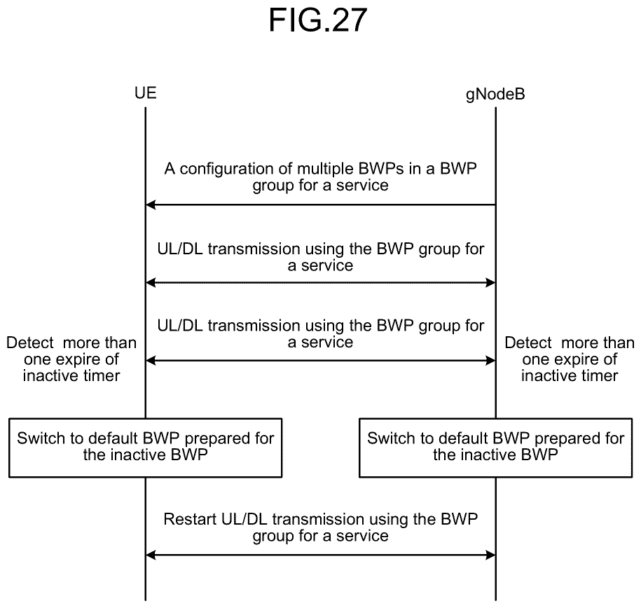

FIG. 27 is a sequence diagram illustrating a switch operation using an inactive timer. First, the base station 20 notifies the terminal device 30 that a plurality of BWPs is set as a BWP group. At this time, the base station 20 and the terminal device 30 set an inactive timer for each of a plurality of BWPs in the BWP group. Then, the base station 20 and the terminal device 30 perform communication using a plurality of BWPs belonging to the BWP group. When detecting the expire of the inactive timer in at least one of the plurality of BWPs, the base station 20 and the terminal device 30 switch the expired BWP to the default BWP. The default BWP is prepared for each property (for example, SST) of the BWP. When the switching is completed, the base station 20 and the terminal device 30 resume communication by using the default BWP.

According to the present solution, even in a case where one service uses a plurality of BWPs, communication interruption of the BWPs can be efficiently handled.

### 8. MODIFICATION

The above-described embodiments are examples, and various modifications and applications are possible.

For example, in the above-described embodiment, at least one of the plurality of BWPs included in the BWP group has a subcarrier spacing different from that of other BWPs in the BWP group. However, all the plurality of BWPs included in the BWP group may have the same subcarrier spacing. More efficient operation is enabled.

The control device that controls the management device 10, the base station 20, and the terminal device 30 of the present embodiment may be implemented by a dedicated computer system or a general-purpose computer system.

For example, a communication program for executing the above-described operation is stored and distributed in a computer-readable recording medium such as an optical disk, a semiconductor memory, a magnetic tape, or a flexible disk. Then, for example, by installing the program in a computer and executing the above-described processing, the control device can be configured. At this time, the control device may be a device (for example, a personal computer) outside the management device 10, the base station 20, and the terminal device 30. Furthermore, the control device may be a device (for example, the control unit 13, the control unit 23, and the control unit 33) inside the management device 10, the base station 20, and the terminal device 30.

In addition, the communication program may be stored in a disk device included in a server device on a network such as the Internet so that the communication program can be downloaded to a computer. Furthermore, the above-described functions may be implemented by cooperation of an operating system (OS) and application software. In this case, a portion other than the OS may be stored in a medium and distributed, or a portion other than the OS may be stored in a server device, and downloading to a computer, or the like can be performed.

Furthermore, among the processes described in the above embodiments, all or part of the processes described as being performed automatically can be performed manually, or all or part of the processes described as being performed manually can be performed automatically by a publicly known method. Further, the processing procedure, specific name, and information including various data and parameters illustrated in the document and the drawings can be arbitrarily changed unless otherwise specified. For example, the various types of information illustrated in each figure are not limited to the illustrated information.

Further, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in any unit according to various loads, usage conditions, and the like. Note that this configuration by distribution and integration may be performed dynamically.

Further, the above-described embodiments can be appropriately combined in a region in which the processing contents do not contradict each other. Furthermore, the order of respective steps illustrated in the flowcharts of the above-described embodiments can be changed as appropriate.

Furthermore, for example, the present embodiment can be implemented as any configuration constituting a device or a system, for example, a processor as a system large scale integration (LSI) or the like, a module using a plurality of processors or the like, a unit using a plurality of modules or the like, a set obtained by further adding other functions to a unit, or the like (that is, a configuration of a part of the device).

Note that, in the present embodiment, the system means a set of a plurality of components (devices, modules (parts), and the like), and it does not matter whether or not all the components are in the same housing. Therefore, a plurality of devices housed in separate housings and connected via a network and one device in which a plurality of modules is housed in one housing are both systems.

Furthermore, for example, the present embodiment can employ a configuration of cloud computing in which one function is shared and processed by a plurality of devices in cooperation via a network.

### 9. CONCLUSION

As described above, the communication system 1 of the present embodiment includes the base station 20 and the terminal device 30. The base station 20 transmits, to the terminal device 30, information for setting a plurality of BWPs as one BWP group for a predetermined operation (for example, a predetermined communication service such as XR). The terminal device 30 sets the plurality of BWPs as one BWP group for a predetermined operation (for example, a predetermined communication service such as XR) on the basis of the information received from the base station 20. Then, the terminal device 30 performs communication related to the predetermined operation using the plurality of BWPs included in the BWP group.

Thus, it is possible to efficiently handle a plurality of BWPs dependent on one service, and thus, it is possible to cope with diversification of communication services.

Although the embodiments of the present disclosure have been described above, the technical scope of the present disclosure is not limited to the above-described embodiments as it is, and various modifications can be made without departing from the gist of the present disclosure. Furthermore, components of different embodiments and modification examples may be appropriately combined.

Furthermore, the effects in the embodiments described in the present description are merely examples and are not limited, and other effects may be provided.

Note that the present technology can also have the following configurations.

(1)

A communication method, comprising:
setting a plurality of BWPs as one BWP group for a predetermined operation; and
performing communication related to the predetermined operation using the plurality of BWPs included in the BWP group.
   (2)

The communication method according to (1), comprising:
receiving setting information for setting the plurality of BWPs as one BWP group for the predetermined operation from a base station; and
setting the plurality of BWPs as one BWP group for the predetermined operation on a basis of the setting information received from the base station.
   (3)

The communication method according to (2), wherein
the base station is configured to generate the setting information on a basis of information from a core network, and
the communication method comprises:
transmitting a request for setting a plurality of BWPs as one BWP group for a predetermined operation to the core network, and
receiving the setting information from the base station that has generated the setting information on a basis of information from the core network.
   (4)

The communication method according to (2), comprising:
receiving pattern information in which a switching pattern of BWPs in the BWP group is described; and
switching BWPs among the plurality of BWPs in the BWP group according to the pattern information.
   (5)

The communication method according to (4), wherein
the pattern information is information notification of which is semi-statically provided from the base station.
   (6)

The communication method according to (4) or (5), comprising:
receiving a plurality of pieces of pattern information in which switching patterns of BWPs in different BWP groups are described; and
switching the current switching pattern to another of the switching patterns on a basis of a notification from the base station.
   (7)

The communication method according to (6), wherein
the current switching pattern is switched to another of the switching patterns on a basis of a dynamic notification from the base station.
   (8)

The communication method according to any one of (1) to (7), comprising:
receiving a dynamic notification from a base station that gives an instruction of switches of the plurality of BWPs included in the BWP group at a same timing; and
switching each of the plurality of BWPs included in the BWP group to another of the BWPs on a basis of the dynamic notification from the base station.
   (9)

The communication method according to (8), wherein
an instruction of the switches of the plurality of BWPs included in the BWP group is an instruction performed in each of the plurality of BWPs, and a BWP of a switching destination of another grouped BWP is designated in each of a plurality of instructions.
   (10)

The communication method according to (8), wherein
an instruction of the switches of the plurality of BWPs included in the BWP group is an instruction performed using an ID of the BWP group.
   (11)

The communication method according to any one of (1) to (10), wherein
in a case where the plurality of BWPs included in the BWP group is switched to another of the BWPs, a latest timing among respective switch completion timings of the plurality of BWPs is set as a timing at which switches of the plurality of BWPs are completed.
   (12)

The communication method according to (11), wherein
in a case where an instruction of a switch is received for each of the plurality of BWPs included in the BWP group, a delay of the switches of the plurality of BWPs is measured from a timing of a last received instruction among a plurality of received instructions.
   (13)

The communication method according to (11), wherein
in a case where an instruction of a switch is received for each of the plurality of BWPs included in the BWP group, a switch completion timing of each of the plurality of BWPs is determined on a basis of a reception timing of the instruction of the switch of each of the plurality of BWPs and a switching delay of each of the plurality of BWPs, and a latest timing among the determined switch completion timings is set as a timing at which the switches of the plurality of BWPs are completed.
   (14)

The communication method according to any one of (1) to (10), wherein
each of the plurality of BWPs included in the BWP group is switched to a default BWP set for each property of the BWPs at a predetermined timing.
   (15)

The communication method according to (14), wherein
a different value is set to the default BWP for each Slice Service Type (SST).
   (16)

The communication method according to any one of (1) to (15), wherein
at least one of the plurality of BWPs included in the BWP group has a subcarrier spacing different from subcarrier spacings of other BWPs in the BWP group.
   (17)

A communication method, comprising:
transmitting information for setting a plurality of BWPs as one BWP group for a predetermined operation to a terminal device that performs communication related to the predetermined operation.
   (18)

A communication device, comprising:
a setting unit that sets a plurality of BWPs as one BWP group for a predetermined operation; and
a communication control unit that performs communication related to the predetermined operation using the plurality of BWPs included in the BWP group.
   (19)

A communication device, comprising:
a transmission unit that transmits information for setting a plurality of BWPs as one BWP group for a predetermined operation to a terminal device that performs communication related to the predetermined operation.
   (20)

A communication system comprising a base station and a terminal device, wherein
the base station includes
a transmission unit that transmits information for setting a plurality of BWPs as one BWP group for a predetermined operation to the terminal device, and
the terminal device includes
a setting unit that sets the plurality of BWPs as one BWP group for the predetermined operation on a basis of information received from the base station, and
a communication control unit that performs communication related to the predetermined operation using the plurality of BWPs included in the BWP group.

### REFERENCE SIGNS LIST

1 COMMUNICATION SYSTEM
10 MANAGEMENT DEVICE
20 BASE STATION
30 TERMINAL DEVICE
11 COMMUNICATION UNIT
21, 31 WIRELESS COMMUNICATION UNIT
12, 22, 32 STORAGE UNIT
13, 23, 33 CONTROL UNIT
211, 311 TRANSMISSION PROCESSING UNIT
212, 312 RECEPTION PROCESSING UNIT
213, 313 ANTENNA

1. A communication method, comprising:
setting a plurality of BWPs as one BWP group for a predetermined operation; and
performing communication related to the predetermined operation using the plurality of BWPs included in the BWP group.

2. The communication method according to claim 1, comprising:
receiving setting information for setting the plurality of BWPs as one BWP group for the predetermined operation from a base station; and
setting the plurality of BWPs as one BWP group for the predetermined operation on a basis of the setting information received from the base station.

3. The communication method according to claim 2, wherein
the base station is configured to generate the setting information on a basis of information from a core network, and
the communication method comprises:
transmitting a request for setting a plurality of BWPs as one BWP group for a predetermined operation to the core network, and
receiving the setting information from the base station that has generated the setting information on a basis of information from the core network.

4. The communication method according to claim 2, comprising:
receiving pattern information in which a switching pattern of BWPs in the BWP group is described; and
switching BWPs among the plurality of BWPs in the BWP group according to the pattern information.

5. The communication method according to claim 4, wherein
the pattern information is information notification of which is semi-statically provided from the base station.

6. The communication method according to claim 4, comprising:
receiving a plurality of pieces of pattern information in which switching patterns of BWPs in different BWP groups are described; and
switching the current switching pattern to another of the switching patterns on a basis of a notification from the base station.

7. The communication method according to claim 6, wherein
the current switching pattern is switched to another of the switching patterns on a basis of a dynamic notification from the base station.

8. The communication method according to claim 1, comprising:
receiving a dynamic notification from a base station that gives an instruction of switches of the plurality of BWPs included in the BWP group at a same timing; and
switching each of the plurality of BWPs included in the BWP group to another of the BWPs on a basis of the dynamic notification from the base station.

9. The communication method according to claim 8, wherein
an instruction of the switches of the plurality of BWPs included in the BWP group is an instruction performed in each of the plurality of BWPs, and a BWP of a switching destination of another grouped BWP is designated in each of a plurality of instructions.

10. The communication method according to claim 8, wherein
an instruction of the switches of the plurality of BWPs included in the BWP group is an instruction performed using an ID of the BWP group.

11. The communication method according to claim 1, wherein
in a case where the plurality of BWPs included in the BWP group is switched to another of the BWPs, a latest timing among respective switch completion timings of the plurality of BWPs is set as a timing at which switches of the plurality of BWPs are completed.

12. The communication method according to claim 11, wherein
in a case where an instruction of a switch is received for each of the plurality of BWPs included in the BWP group, a delay of the switches of the plurality of BWPs is measured from a timing of a last received instruction among a plurality of received instructions.

13. The communication method according to claim 11, wherein
in a case where an instruction of a switch is received for each of the plurality of BWPs included in the BWP group, a switch completion timing of each of the plurality of BWPs is determined on a basis of a reception timing of the instruction of the switch of each of the plurality of BWPs and a switching delay of each of the plurality of BWPs, and a latest timing among the determined switch completion timings is set as a timing at which the switches of the plurality of BWPs are completed.

14. The communication method according to claim 1, wherein
each of the plurality of BWPs included in the BWP group is switched to a default BWP set for each property of the BWPs at a predetermined timing.

15. The communication method according to claim 14, wherein
a different value is set to the default BWP for each Slice Service Type (SST).

16. The communication method according to claim 1, wherein
at least one of the plurality of BWPs included in the BWP group has a subcarrier spacing different from subcarrier spacings of other BWPs in the BWP group.

17. A communication method, comprising:
transmitting information for setting a plurality of BWPs as one BWP group for a predetermined operation to a terminal device that performs communication related to the predetermined operation.

18. A communication device, comprising:
a setting unit that sets a plurality of BWPs as one BWP group for a predetermined operation; and
a communication control unit that performs communication related to the predetermined operation using the plurality of BWPs included in the BWP group.

19. A communication device, comprising:
a transmission unit that transmits information for setting a plurality of BWPs as one BWP group for a predetermined operation to a terminal device that performs communication related to the predetermined operation.

20. A communication system comprising a base station and a terminal device, wherein
the base station includes
a transmission unit that transmits information for setting a plurality of BWPs as one BWP group for a predetermined operation to the terminal device, and
the terminal device includes
a setting unit that sets the plurality of BWPs as one BWP group for the predetermined operation on a basis of information received from the base station, and
a communication control unit that performs communication related to the predetermined operation using the plurality of BWPs included in the BWP group.
